(19) United States
(12) Patent Application Publication
(10) Pub. No.: US 2018/0027452 A1
(43) Pub. Date: Jan. 25, 2018

(54) BASE STATION, TERMINAL, AND WIRELESS COMMUNICATION SYSTEM

(71) Applicant: FUJITSU LIMITED, Kawasaki-shi (JP)

(72) Inventor: YOSHINORI TANAKA, Yokohama (JP)

(73) Assignee: FUJITSU LIMITED, Kawasaki-shi, Kanagawa (JP)

(21) Appl. No.: 15/722,626

(22) Filed: Oct. 2, 2017

Related U.S. Application Data
(63) Continuation of application No. PCT/JP2015/060878, filed on Apr. 7, 2015.

(51) Int. Cl. H04W 28/18; H04L 1/00; H04B 17/336; H04W 24/10

(52) U.S. Cl. CPC H04W 28/18; H04W 24/10; H04L 1/0003; H04L 1/0009; H04B 17/336; H04W 88/02

(57) ABSTRACT

A base station includes an unlicensed-band receiving unit, a determining unit, an error-rate calculating unit, and an uplink managing unit. The unlicensed-band receiving unit receives data that is transmitted from a terminal in the band that is used for a wireless communication. The determining unit determines whether the data, received by the unlicensed-band receiving unit, is collision data or non-collision data. The error-rate calculating unit calculates an error rate on the basis of data that is determined to be non-collision data by the determining unit among data that are received by the unlicensed-band receiving unit. The uplink managing unit corrects the index, which is used to select a modulation method and a coding rate when the terminal transmits data, on the basis of the error rate that is calculated by the error-rate calculating unit.

### CROSS-REFERENCE TO RELATED APPLICATION

This application is a continuation of International Application No. PCT/JP2015/060878, filed on Apr. 7, 2015, the entire contents of which are incorporated herein by reference.

### FIELD

The embodiments discussed herein are related to a base station, a terminal, a wireless communication system, a method for controlling the base station, and a method for controlling the terminal.

### BACKGROUND

In recent years, next-generation wireless communication technologies have been discussed with regard to wireless communication systems, such as mobile phone systems, in order to further increase speed, capacity, or the like, of wireless communication. For example, with regard to the communication standard called Long Term Evolution (LTE), considerations have been given on the technology for performing communications by using a carrier wave (LC: licensed band carrier) at a frequency band, for which a license is needed, and a carrier wave (UC: unlicensed band carrier) at a frequency band, for which a license is not needed. The technology is called Licensed-Assisted Access (LAA).

During the communication using the frequency band, for which a license is needed, Modulation and Coding Scheme (MCS) control is conducted so that the base station measures the reception quality of signals, transmitted from a terminal, and based on the measured reception quality, controls a modulation method, or the like, for data that is transmitted by the terminal to the base station. During the MCS control, the base station calculates the index that corresponds to the reception quality of signals that are received from the terminal. Then, on the basis of the calculated index, the base station determines such a modulation method, or the like, that the reception quality in the base station falls within a predetermined range and instructs the determined modulation method, or the like, to the terminal. The terminal uses the modulation method, or the like, instructed by the base station, to transmit data.

However, even if the terminal transmits data by using the modulation method, or the like, which is selected on the basis of the reception quality in the base station, an appropriate MCS is sometimes not selected due to factors, such as channel fluctuations, so that the error rate of the data, received by the base station, is increased. To prevent the above, the base station sometimes conducts MCS outer loop control to correct the threshold, used for MCS selection, in accordance with the error rate of the data that is received from the terminal. Thus, if the error rate in the base station is high, a modulation method, or the like, with high error resilience is likely to be selected, and the error rate in the base station may be decreased. Furthermore, the MCS control and the MCS outer loop control are performed for down transmissions from the base station in the same manner. Prior art example is disclosed in Japanese National Publication of International Patent Application No. 2013-504951.

Furthermore, in the LAA, communications are also performed by using the UC, which is the frequency band that does not need a license. For communications using the UC, Carrier Sense Multiple Access/Collision Avoidance (CSMA/CA) system is often used. It is considered that, during communications using the CSMA/CA system, for example, the base station executes Listen Before Talk (LBT) in the UC and, if it is detected that the UC is idle, instructs the terminal to do transmission in the uplink. However, in some transmission timing of the terminal, the transmitted data sometimes collides with the signals that are transmitted from a different communication device in the transmission band at the same time as the data. In the base station, the collision data is often determined to be a reception error. Furthermore, the base station calculates the error rate on the basis of the error of the received data regardless of whether there is a collision or not, as it is difficult to determine whether a collision occurs according to the received data.

Therefore, in a case where data collisions do not occur, a high error rate is calculated on the whole as a reception error of the data, in which a collision occurs, is considered even though the error rate is low. Thus, during the MCS outer loop control, a modulation method, or the like, with higher error resilience is likely to be used. With regard to modulation methods, or the like, as the method has higher error resilience, the throughput of transmitted data is lower. Therefore, the throughput of transmitted data is decreased.

### SUMMARY

According to an aspect of an embodiment, a base station that is used in a wireless communication system in which the base station and a terminal perform a wireless communication by using a band after detecting a vacancy in the band at a predetermined frequency, the base station includes a receiving unit, a determining unit, a calculating unit, and a correcting unit. The receiving unit receives data that is transmitted from the terminal in the band. The determining unit determines whether data received by the receiving unit is collision data, which is data transmitted from the terminal at same time as a signal transmitted from a different communication device in the band, or non-collision data, which is not the collision data. The calculating unit calculates an error rate based on data that is determined to be non-collision data by the determining unit among data that are received by the receiving unit. The correcting unit corrects an index, which is used to select a modulation method and a coding rate when the terminal transmits data, based on the error rate.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram that illustrates an example of a wireless communication system;

FIG. 2 is a diagram that illustrates an example of the operation of the wireless communication system;

FIG. 3 is a block diagram that illustrates an example of a base station according to a first embodiment;

FIG. 4 is a diagram that illustrates an example of the method for determining the SIR threshold;

FIG. 5 is a diagram that illustrates another example of the method for determining the SIR threshold;

FIG. 6 is a block diagram that illustrates an example of a terminal according to the first embodiment;

FIG. 7 is a flowchart that illustrates an example of the process to calculate the SIR threshold;

FIG. 8 is a flowchart that illustrates an example of the MCS outer loop control in the UL;

FIG. 9 is a flowchart that illustrates an example of the process to change the carrier sense threshold or the CW size;

FIG. 10 is a block diagram that illustrates an example of a base station according to a second embodiment;

FIG. 11 is a block diagram that illustrates an example of the terminal according to the second embodiment;

FIG. 12 is a diagram that illustrates an example of the wireless communication system;

FIG. 13 is a block diagram that illustrates an example of the base station according to a third embodiment;

FIG. 14 is a block diagram that illustrates an example of the terminal according to the third embodiment;

FIG. 15 is a flowchart that illustrates an example of the operation of the terminal according to the third embodiment;

FIG. 16 is a flowchart that illustrates an example of the MCS outer loop control in the DL; and

FIG. 17 is a diagram that illustrates an example of a wireless communication device that performs the function of the base station or the terminal.

### DESCRIPTION OF EMBODIMENT(S)

Preferred embodiments of the present invention will be explained with reference to accompanying drawings. Furthermore, the disclosed technology is not limited to the following embodiments. Moreover, each of the embodiments may be appropriately combined to such a degree that there is no contradiction in processing details.

### [a] First Embodiment

Wireless Communication System 10

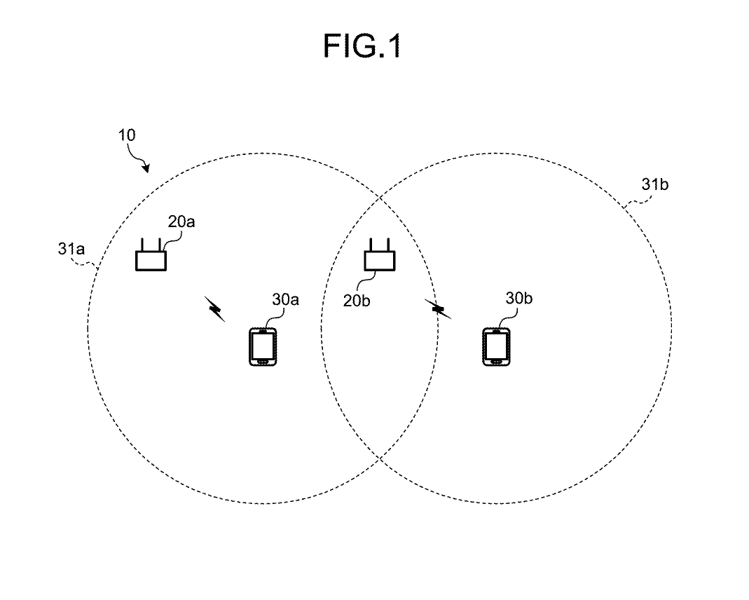

FIG. 1 is a diagram that illustrates an example of a wireless communication system 10. The wireless communication system 10 includes base stations 20a to 20b and terminals 30a to 30b. Furthermore, hereinafter, each of the base stations 20a to 20b is described as a base station 20 if they are collectively referred to without being discriminated, and each of the terminals 30a to 30b is described as a terminal 30 if they are collectively referred to without being discriminated.

The base station 20 and the terminal 30 perform wireless communications based on for example the LTE. The base station 20 is for example the evolved Node B (eNB) in the LTE. The terminal 30 is for example user equipment (UE) in the LTE. The terminal 30a belongs to the cell that is managed by the base station 20a, and it performs wireless communications with the base station 20a in the cell. Furthermore, the terminal 30b belongs to the cell that is managed by the base station 20b, and it performs wireless communications with the base station 20b in the cell. Moreover, in the following explanations, the base station 20 and the terminal 30 are sometimes described as an LTE system.

The base station 20 performs wireless communications with the terminal 30 in the cell by using a first band, which is dedicated to the LTE system to which the base station 20 belongs, and a second band, which is shared by the LTE system to which the base station 20 belongs and a different communication system. The first band is for example a licensed band carrier (LC) in the band of 2 GHz. The second band is for example an unlicensed band carrier (UC) in the band of 5 GHz. Hereinafter, the first band is referred to as a licensed band and the second band as an unlicensed band.

In the LTE system, to which the base station 20 belongs, the first band is assigned to for example the primary component carrier (PCC), and the second band is assigned to for example the secondary component carrier (SCC). Furthermore, in FIG. 1, the reference numeral 31a denotes the range within which the radio waves, transmitted from the terminal 30a, reach with such intensity that it is determined to be busy during the carrier sense by any communication device. Furthermore, the reference numeral 31b denotes the range within which the radio waves, transmitted from the terminal 30b, reach with such intensity that it is determined to be busy during the carrier sense by any communication device.

Here, in the unlicensed band, before a communication is started, a communication device on the transmitting side or on the receiving side, which performs a communication, executes LBT to determine whether there is a vacancy in the band before a communication is started, and it determines whether a vacancy in the band continues for a predetermined time period. Then, if a vacancy in the band continues for a predetermined time period, the communication device starts a communication after detecting that a vacancy in the band continues during the random backoff period. However, when the band is shared by many communication devices, there is a high possibility that the backoff periods of the communication devices are the same even if the backoff periods are random. Thus, there is a higher possibility that transmissions are simultaneously conducted, and there is a higher possibility that the pieces of data, transmitted from the communication devices, are collided. Here, the collision means, for example, reception of data, including a large interference, at a communication device on the receiving side as a result of simultaneous transmissions from multiple communication devices in the band at the same frequency.

Operation of the Wireless Communication System 10

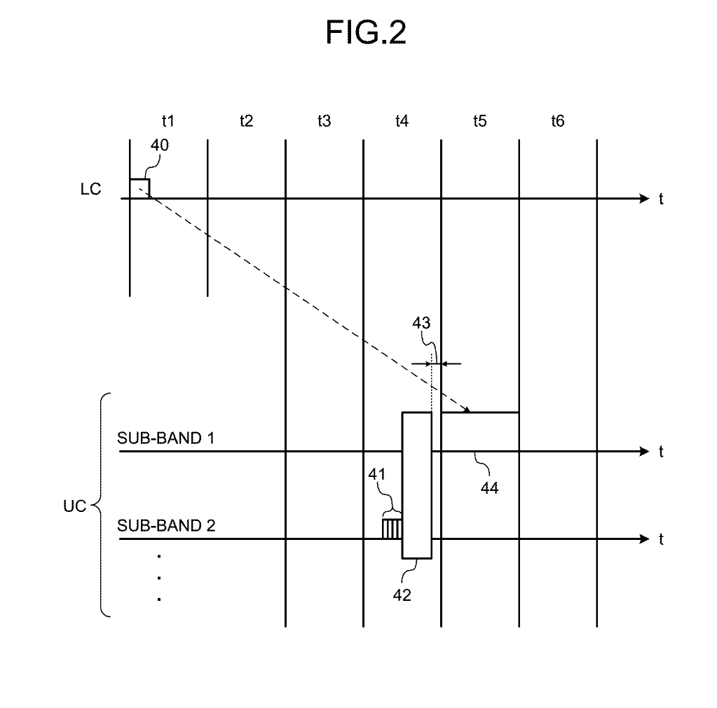

FIG. 2 is a diagram that illustrates an example of the operation of the wireless communication system 10. FIG. 2 illustrates operations of the base station 20 and the terminal 30 as a pair. In FIG. 2, the upper section illustrates signals that are transmitted by using the LC, and the lower section illustrates signals that are transmitted by using the UC. Furthermore, in FIG. 2, the horizontal axis represents the flow of time, and t1 to t6 represent a period (e.g., 1 millisecond) in units of sub-frames. For example, as illustrated in FIG. 2, the unlicensed band is divided into multiple sub-bands. According to the present embodiment, the unlicensed band is for example 20 MHz, and it is divided into four sub-bands in an interval of for example 5 MHz.

For example, as illustrated in FIG. 2, the base station 20 generates an uplink (UL) grant 40 to request data transmission in the UL if a data transmission request is generated for the terminal 30. Then, the base station 20 transmits the generated UL grant 40 to the terminal 30 in the licensed band. The UL grant 40 contains the information on the resource (e.g., a sub-band of the unlicensed band) that is used for data transmission in the UL. Furthermore, the UL grant 40 may be transmitted in the unlicensed band.

Then, the base station 20 executes the LBT in the unlicensed band at a predetermined time period (e.g., after 3 sub-frames) after the UL grant 40 is transmitted. Then, if it is detected that the unlicensed band is idle and it is confirmed that the idle state continues during the random backoff period 41, the base station 20 transmits a reservation signal 42 by using all the sub-bands in the unlicensed band. According to the present embodiment, the reservation signal 42 is for example a clear to send (CTS) signal.

If the UL grant 40 is received in the licensed band, the terminal 30 waits for the reservation signal 42 in the unlicensed band. If the reservation signal 42 is detected, the terminal 30 transmits a signal 44 to the base station 20 in the sub-band, designated by the UL grant 40, after transmission of the reservation signal 42 has been completed and a short inter frame space (SIFS) period 43 has elapsed.

Furthermore, in the wireless communication system 10, illustrated in FIG. 1, even if the terminal 30b transmits data to the base station 20b, the radio waves, transmitted from the terminal 30b, do not reach the base station 20a or the terminal 30a. Therefore, even if the terminal 30b transmits data to the base station 20b, the base station 20a sometimes determines that the unlicensed band is idle during the LBT. If it is detected that the unlicensed band is idle at a predetermined time period after a UL grant is transmitted to the terminal 30a, the base station 20a transmits a reservation signal to the unlicensed band. If the reservation signal is detected in the unlicensed band, the terminal 30a, which has received the UL grant, starts to transmit data in the UL in the unlicensed band after the reservation signal is terminated.

As illustrated in FIG. 1, the radio waves, transmitted from the terminal 30a in the unlicensed band, are received by the base station 20b with a predetermined intensity. Therefore, while the base station 20b receives data from the terminal 30b, there may be a case where the data that is transmitted from the terminal 30b collides with the data that is transmitted from the terminal 30a. Thus, in the base station 20b, there is an increase in the error rate for reception of data that is transmitted from the terminal 30b due to the collision with the data that is transmitted from the terminal 30a.

Here, the base station 20 according to the present embodiment executes MCS control to select a modulation method, or the like, of the terminal 30 in the UL on the basis of reception quality of signals that are transmitted from the terminal 30. During the MCS control, the base station 20 calculates the index to select a modulation method, or the like, of the terminal 30 in the UL on the basis of the reception quality of signals that are transmitted from the terminal 30, and it identifies the modulation method, or the like, which are related to the calculated index, by referring to the previously stored correspondence table. The identified modulation method, or the like, is notified to the terminal 30 via for example the licensed band, and the terminal 30 uses the notified modulation method, or the like, to conduct data transmission in the UL.

Furthermore, the base station 20 according to the present embodiment executes MCS outer loop control on the basis of the error rate of data that is received from the terminal 30. During the MCS outer loop control, the above-described index is corrected on the basis of the error rate of the data that is received from the terminal 30 such that the error rate becomes closer to the target value.

Here, if the data that is transmitted from the terminal 30 to the base station 20 collides with the data that is transmitted from a different communication device, there is an increase in the error rate of the data that is received by the base station 20. If the MCS outer loop control is executed in accordance with the average value of the error rate of reception data, a modulation method, or the like, with a low transmission rate is selected even in a state where data collisions do not occur. This results in a decrease in the transmission rate in the UL.

To prevent this, the base station 20 according to the present embodiment discriminates between collision data, which is the data that has been collided, and non-collision data, which is the data that has not been collided, among the data that are received from the terminal 30. Then, the base station 20 executes the MCS outer loop control on the basis of the error rate that is calculated by using non-collision data. Thus, the throughput of the UL may be improved in a state where data collisions do not occur, and the overall throughput of the UL may be improved.

The Base Station 20

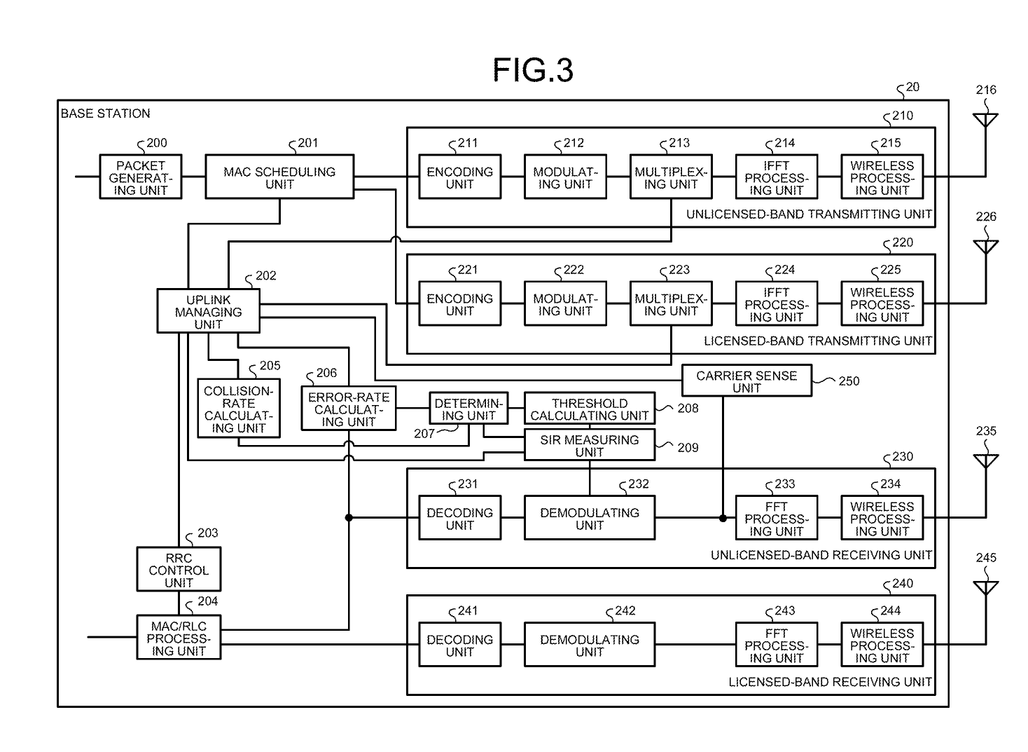

FIG. 3 is a block diagram that illustrates an example of the base station 20 according to the first embodiment. The base station 20 includes a packet generating unit 200, a media access control (MAC) scheduling unit 201, an uplink managing unit 202, a radio resource control (RRC) control unit 203, and a MAC/RLC (radio link control) processing unit 204. Furthermore, the base station 20 includes a collision-rate calculating unit 205, an error-rate calculating unit 206, a determining unit 207, a threshold calculating unit 208, an SIR measuring unit 209, and a carrier sense unit 250. Furthermore, the base station 20 includes an unlicensed-band transmitting unit 210, a licensed-band transmitting unit 220, an unlicensed-band receiving unit 230, a licensed-band receiving unit 240, an antenna 216, an antenna 226, an antenna 235, and an antenna 245. Furthermore, according to the present embodiment, the antenna 216, the antenna 226, the antenna 235, and the antenna 245 are implemented by using different antennas; however, according to another embodiment, these antennas may be implemented by using a single antenna.

The licensed-band receiving unit 240 performs processing to decode data from signals that are received in the licensed band. The licensed-band receiving unit 240 includes a decoding unit 241, a demodulating unit 242, an FFT processing unit 243, and a wireless processing unit 244.

The wireless processing unit 244 performs wireless processing on signals that are received via the antenna 245. The wireless processing, performed by the wireless processing unit 244, includes for example processing to convert the frequency of a received signal from the frequency of the licensed band to the frequency of the base band. The wireless processing unit 244 outputs received signal, on which wireless processing has been performed, to the FFT processing unit 243.

The FFT processing unit 243 performs Fast Fourier Transform (FFT) processing on reception signals that are output from the wireless processing unit 244. Thus, reception signals, which have been converted in the frequency from the licensed band to the base band, are converted from the time domain to the frequency domain. The FFT processing unit 243 outputs reception signals, on which FFT processing has been performed, to the demodulating unit 242.

The demodulating unit 242 demodulates reception signals that are output from the FFT processing unit 243. Then, the demodulating unit 242 outputs the demodulated reception signals to the decoding unit 241. The decoding unit 241 decodes reception signals that are output from the demodulating unit 242. Then, the decoding unit 241 outputs the decoded reception data to the MAC/RLC processing unit 204.

The unlicensed-band receiving unit 230 performs processing to decode data from the signals that are received in the unlicensed band. The unlicensed-band receiving unit 230 includes a decoding unit 231, a demodulating unit 232, an FFT processing unit 233, and a wireless processing unit 234.

The wireless processing unit 234 performs wireless processing on signals that are received via the antenna 235. The wireless processing, performed by the wireless processing unit 234, includes for example processing to convert the frequency of reception signals from the frequency of the unlicensed band to the frequency of the base band. The wireless processing unit 234 outputs reception signals, on which the wireless processing has been performed, to the FFT processing unit 233.

The FFT processing unit 233 performs FFT processing on reception signals that are output from the wireless processing unit 234. Thus, reception signals, which have been converted in the frequency from the unlicensed band to the base band, are converted from the time domain to the frequency domain. The FFT processing unit 233 outputs reception signals, on which the FFT processing has been performed, to the demodulating unit 232 and the carrier sense unit 250.

The demodulating unit 232 demodulates reception signals that are output from the FFT processing unit 233. Then, the demodulating unit 232 outputs the demodulated reception signals to the decoding unit 231 and the SIR measuring unit 209. The decoding unit 231 decodes reception signals that are output from the demodulating unit 232 and determines an error in the reception data. Then, the decoding unit 231 outputs the decoded reception data to the MAC/RLC processing unit 204. Furthermore, the decoding unit 231 outputs an error determination result of each piece of reception data to the error-rate calculating unit 206.

The carrier sense unit 250 conducts carrier sense in the unlicensed band on the basis of reception signals that are output from the FFT processing unit 233. The carrier sense unit 250 determines that the unlicensed band is busy if the interference power of the unlicensed band is equal to or more than the carrier sense threshold. Conversely, the carrier sense unit 250 determines that the unlicensed band is idle if the interference power of the unlicensed band is less than the carrier sense threshold. Then, the carrier sense unit 250 outputs a determination result of the carrier sense to the uplink managing unit 202. Furthermore, the carrier sense unit 250 changes the carrier sense threshold in accordance with an instruction from the uplink managing unit 202.

The MAC/RLC processing unit 204 performs processing in the MAC layer and processing in the RLC layer on the basis of data that is output from the decoding unit 231 and the decoding unit 241. The MAC/RLC processing unit 204 outputs data, obtained during processing in each layer, to for example a higher-level device of the base station 20. Furthermore, the MAC/RLC processing unit 204 outputs the control information that is included in the data, obtained during processing in each layer, to the RRC control unit 203.

The RRC control unit 203 conducts wireless resource control on the basis of the control information that is output from the MAC/RLC processing unit 204. The wireless resource control, executed by the RRC control unit 203, is processing in the RRC layer. The RRC control unit 203 generates the control information in accordance with the wireless resource control and outputs the generated control information to the uplink managing unit 202.

The SIR measuring unit 209 measures the signal to interference ratio (SIR) for each piece of data that is received from the terminal 30 on the basis of reception signals that are output from the demodulating unit 232. The SIR measuring unit 209 measures, for example, the average value E(I) of the interference power in the unlicensed band in a case where idleness is determined by the carrier sense unit 250 and the received power S of the data that is received from the terminal 30. Then, for each piece of reception data, the SIR measuring unit 209 divides the received power S by the average value E(I) of the interference power, thereby calculating the SIR. Then, the SIR measuring unit 209 outputs the SIR, calculated for each piece of reception data, to the determining unit 207 and the threshold calculating unit 208.

Furthermore, the SIR measuring unit 209 may calculate the SIR in accordance with the following Equation (1) on the basis of the received power of the pilot signal, which is accompanied with the reception data, and the error power between the pilot signal and its determination value.

$$S I R = \frac{{r}^{2}}{{( r - \hat{r} )}^{2}} \qquad ( 1 )$$

where

r² is the received power of the pilot signal,

\hat{r} is the determination value of the pilot signal,

(r−\hat{r})² is the error power between the pilot signal and its determination value.

The threshold calculating unit 208 calculates the SIR threshold, which is the threshold for determining whether the reception data is collision data or non-collision data, on the basis of the distribution of the SIR that is calculated for each piece of reception data by the SIR measuring unit 209. For example, the threshold calculating unit 208 calculates the SIR threshold on the basis of the distribution of the SIR of a predetermined number of pieces (e.g., several thousands to several tens of thousands of pieces) of data that are received from the terminal 30 in a situation where there is a low possibility that the data, transmitted from the terminal 30, collides with the data that is transmitted from a different communication device. The situation where there is a low possibility that the data, transmitted from the terminal 30, collides with the data that is transmitted from a different communication device may be achieved for example by setting the contention window (CW) size, used by the base station 20 during the LBT, to the largest value that may be specified. Thus, there may be a lower possibility that the backoff period, selected by the base station 20, is the same as the backoff period of a different communication device, and there may be a lower possibility that the data, transmitted from the terminal 30, collides with the data that is transmitted from a different communication device.

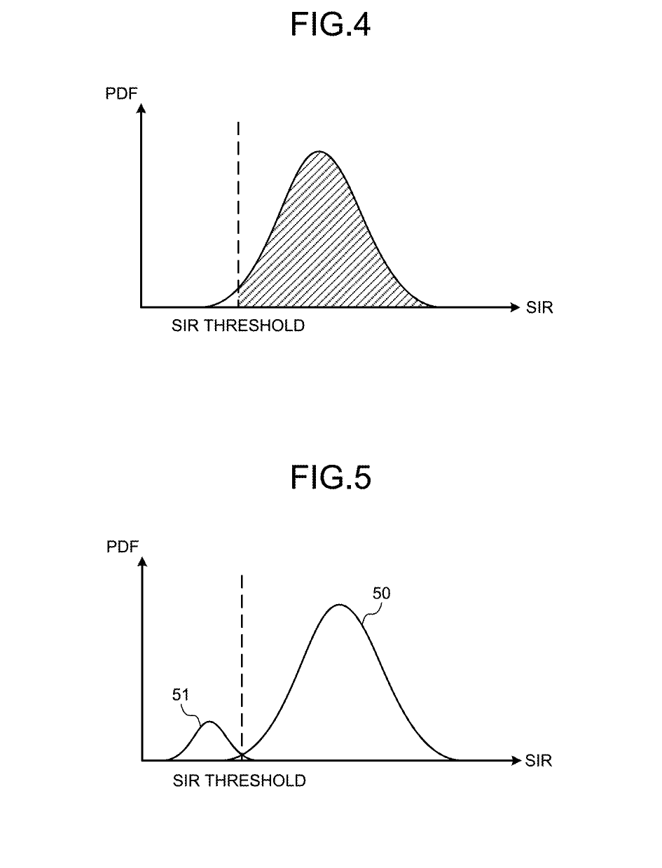

If the distribution of the SIR of the data, received from the terminal 30, is the probability density function (PDF) that is illustrated in FIG. 4, for example, the SIR measuring unit 209 calculates, as the SIR threshold, the lower limit value in the range that includes the SIR of the reception data at a predetermined ratio from the high SIR. According to the present embodiment, the SIR measuring unit 209 calculates, as the SIR threshold, the lower limit value in the range that includes the reception data in the top 90%, for example, from the high SIR.

Furthermore, the “predetermined ratio” in the range that includes the reception data at the predetermined ratio from the high SIR is set to, for example, the value that is equal to or more than (1−T_{BLER}/100) if the target error rate of the reception data is T_{BLER}(%). For example, the target error rate T_{BLER} of the reception data is 10%, the “predetermined ratio” in the range that includes the reception data at the predetermined ratio from the high SIR is set to the value that is equal to or more than 1−T_{BLER}/100=0.9=90%.

Furthermore, the threshold calculating unit 208 may use another method as the method for calculating the SIR threshold. For example, the threshold calculating unit 208 collects the SIRs of a predetermined number of pieces (e.g., several thousands to several tens of thousands of pieces) of reception data, measured by the SIR measuring unit 209, in the normal operating state. In the normal operating state, there may be a case where the randomly selected backoff periods are the same for the communication devices that use the unlicensed band, and there may be a case where the data, transmitted from the terminal 30, collides with the data that is transmitted from a different communication device. In the normal operating state, the distribution of the SIRs of the predetermined number of pieces of reception data, measured by the SIR measuring unit 209, is the distribution that is illustrated in FIG. 5, for example.

For example, as illustrated in FIG. 5, the sketch of the PDF, which represents the distribution of the SIR of the reception data that do not collide with the data, transmitted from a different communication device, among the data that are transmitted from the terminal 30, is for example a curved line 50. Conversely, the sketch of the PDF, which represents the distribution of the SIR of the reception data that collides with the data, transmitted from a different communication device, among the data that are transmitted from the terminal 30, is for example a curved line 51. Collision data and non-collision data are present in a mixed manner in the predetermined number of pieces of reception data, measured by the SIR measuring unit 209. Therefore, the sketch of the PDF of the SIRs of the predetermined number of pieces of reception data, measured by the SIR measuring unit 209, is the shape that combines the curved line 50 and the curved line 51.

For example, the threshold calculating unit 208 regards the PDF of the SIRs of the predetermined number of pieces of reception data, measured by the SIR measuring unit 209, as a mixed distribution that includes two SIR normal distributions of the collision data and the non-collision data. Furthermore, the threshold calculating unit 208 uses for example the expectation maximization (EM) algorithm to conduct maximum likelihood estimation on each component distribution parameter, thereby separating the PDF of the SIR of the collision data and the PDF of the SIR of the non-collision data. Then, for example, the threshold calculating unit 208 calculates, as the SIR threshold, the value of the SIR at the intersection point between the curved line 51, which represents the sketch of the PDF of the SIR of the collision data, and the curved line 50, which represents the sketch of the PDF of the SIR of the non-collision data. Furthermore, the threshold calculating unit 208 may calculate, as the SIR threshold, the lower limit value in the range that includes the SIR of the predetermined ratio of reception data from the high SIR with regard to the PDF of the SIR of the non-collision data.

An explanation is continued with reference back to FIG. 3. For each piece of reception data, the determining unit 207 compares the SIR, calculated by the SIR measuring unit 209, and the SIR threshold, calculated by the threshold calculating unit 208, thereby determining whether each piece of reception data is collision data or non-collision data. Then, the determining unit 207 outputs a determination result of each piece of reception data to the collision-rate calculating unit 205 and the error-rate calculating unit 206. According to the present embodiment, for each piece of reception data, the determining unit 207 determines that the reception data is non-collision data if the SIR, calculated by the SIR measuring unit 209, is equal to or more than the SIR threshold. Conversely, the determining unit 207 determines that the reception data is collision data if the SIR, calculated by the SIR measuring unit 209, is less than the SIR threshold.

For each piece of reception data, the error-rate calculating unit 206 receives a result of error determination from the decoding unit 231 and receives a determination result, which indicates whether it is collision data or not, from the determining unit 207. Then, with regard to the reception data that is determined to be non-collision data by the determining unit 207, the error-rate calculating unit 206 calculates an error rate of the reception data in accordance with a result of the error determination that is conducted by the decoding unit 231. According to the present embodiment, the error-rate calculating unit 206 calculates for example Block Error Rate (BLER), which is an error rate of transport block, as an error rate of reception data. Then, the error-rate calculating unit 206 outputs the calculated error rate to the uplink managing unit 202.

For each piece of reception data, the collision-rate calculating unit 205 receives a determination result, which indicates whether it is collision data or not, from the determining unit 207. Then, the collision-rate calculating unit 205 calculates, as the collision rate, the ratio of pieces of reception data, which is determined to be non-collision data by the determining unit 207, among the pieces of reception data. Then, the collision-rate calculating unit 205 outputs the calculated collision rate to the uplink managing unit 202.

The uplink managing unit 202 controls the MAC layer on the basis of the control information that is output from the RRC control unit 203. Then, the uplink managing unit 202 generates the control information in accordance with the control on the MAC layer and outputs the generated control information to the MAC scheduling unit 201.

Furthermore, if a data transmission request is generated for the terminal 30, the uplink managing unit 202 generates a UL grant to request data transmission in the UL. Then, the uplink managing unit 202 outputs the generated UL grant to a multiplexing unit 223 that is described later.

Furthermore, the uplink managing unit 202 executes the LBT in the unlicensed band in accordance with a determination result that is output from the carrier sense unit 250 at a predetermined timing (e.g., after 3 sub-frames) after the UL grant is transmitted to the terminal 30. Furthermore, if idleness of the unlicensed band is detected, the uplink managing unit 202 generates a reservation signal and outputs the generated reservation signal to a multiplexing unit 213.

Furthermore, the uplink managing unit 202 stores the correspondence table, which stores the combination of the modulation method and the coding rate in the UL in relation to the index that indicates the SIR of reception data. In the correspondence table according to the present embodiment, for example, the index with a large value is related to a modulation method, a coding rate, or the like, with a low error resilience and a high transmission rate, and the index with a small value is related to a modulation method, a coding rate, or the like, with a high error resilience and a low transmission rate. The uplink managing unit 202 conducts MCS control to instruct the modulation method, or the like, which is used in the UL, to the terminal 30 on the basis of the SIR of reception data, calculated by the SIR measuring unit 209. For example, the uplink managing unit 202 refers to the correspondence table to select the modulation method, or the like, which is related to the index that indicates the SIR, on the basis of the SIR that is calculated by the SIR measuring unit 209 for each piece of reception data. Then, the uplink managing unit 202 generates the control information that includes the selected modulation method, or the like, and outputs the generated control information to the multiplexing unit 223 that is described later.

Furthermore, the uplink managing unit 202 executes the MCS outer loop control to correct the index for selecting a modulation method, or the like, on the basis of the error rate that is calculated by the error-rate calculating unit 206. The uplink managing unit 202 adjusts the value of the MCS offset, which is added to the index that indicates the SIR of reception data that is calculated by the SIR measuring unit 209, depending on whether, for example, the error rate, calculated by the error-rate calculating unit 206, is higher than the target value. For example, if the error rate, calculated by the error-rate calculating unit 206, is higher than the target value, the uplink managing unit 202 decreases the value of the MCS offset, which is added to the index that indicates the SIR of reception data, calculated by the SIR measuring unit 209. The MCS offset has a negative value in some cases. Thus, the modulation method, or the like, with high error resilience is likely to be selected, and the error rate is reduced so that the error rate becomes closer to the target value.

Furthermore, for example, if the error rate, calculated by the error-rate calculating unit 206, is lower than the target value, the uplink managing unit 202 increases the value of the MCS offset, which is added to the index that indicates the SIR of reception data that is calculated by the SIR measuring unit 209. Thus, a modulation method, or the like, with low error resilience is likely to be selected, and the error rate is increased so that the error rate becomes closer to the target value.

Furthermore, the uplink managing unit 202 controls at least any one of the CW size and the carrier sense threshold such that the collision rate, output from the collision-rate calculating unit 205, becomes less than the target value of the error rate. For example, if the collision rate, output from the collision-rate calculating unit 205, is larger than the target value of the error rate, the uplink managing unit 202 increases the CW size that is used for LBT or instructs the carrier sense unit 250 to lower the carrier sense threshold. Furthermore, if the multiple terminals 30 are present under the base station 20, the uplink managing unit 202 controls the CW size for LBT, or the like, such that the average value of the collision rate of the reception data from the terminal 30, which is located under the base station 20, becomes lower than the target value of the error rate.

Here, if the data transmitted from the terminal 30 collides with the data transmitted from a different communication device, it results in a reception error in many cases. Therefore, in order to set the error rate of reception data to be equal to or less than the target value, it is effective to set the collision rate of the data transmitted from the terminal 30 to be lower than the target value of the error rate. The uplink managing unit 202 controls at least any one of the CW size and the carrier sense threshold such that the collision rate becomes lower than the target value of the error rate, whereby the target value of the error rate may be achieved.

The packet generating unit 200 generates data that includes user data that is output from a higher-level device. Then, the packet generating unit 200 outputs the generated data to the MAC scheduling unit 201.

The MAC scheduling unit 201 conducts scheduling on the MAC layer with regard to the packet, output from the packet generating unit 200, on the basis of the control information that is output from the uplink managing unit 202. Then, the MAC scheduling unit 201 controls output of the packet, generated by the packet generating unit 200, to the unlicensed-band transmitting unit 210 or the licensed-band transmitting unit 220 in accordance with a result of the scheduling.

The licensed-band transmitting unit 220 performs the process to transmit data in the licensed band. The licensed-band transmitting unit 220 includes an encoding unit 221, a modulating unit 222, the multiplexing unit 223, an Inverse Fast Fourier Transform (IFFT) processing unit 224, and a wireless processing unit 225.

The encoding unit 221 encodes data in the packet that is output from the MAC scheduling unit 201. Then, the encoding unit 221 outputs the encoded data in the packet to the modulating unit 222. The modulating unit 222 modulates the data that is output from the encoding unit 221. Then, the modulating unit 222 outputs the modulated signal to the multiplexing unit 223.

The multiplexing unit 223 multiplexes the control information, which includes designations of a modulation method, or the like, UL grant, etc., output from the uplink managing unit 202, and signals output from the modulating unit 222. Then, the multiplexing unit 223 outputs the multiplexed transmission signals to the IFFT processing unit 224.

The IFFT processing unit 224 performs IFFT processing on transmission signals that are output from the multiplexing unit 223. Thus, transmission signals, output from the multiplexing unit 223, are converted from the frequency domain to the time domain. The IFFT processing unit 224 outputs the transmission signals, on which the IFFT processing has been performed, to the wireless processing unit 225.

The wireless processing unit 225 performs wireless processing on transmission signals that are output from the IFFT processing unit 224. The wireless processing, conducted by the wireless processing unit 225, includes processing to convert for example the frequency of a transmission signal from the frequency of the base band to the frequency of the licensed band. The wireless processing unit 225 transmits transmission signals, on which the wireless processing has been performed, via the antenna 226.

The unlicensed-band transmitting unit 210 performs the process to transmit data in the unlicensed band. The unlicensed-band transmitting unit 210 includes an encoding unit 211, a modulating unit 212, the multiplexing unit 213, an IFFT processing unit 214, and a wireless processing unit 215.

The encoding unit 211 encodes data in a packet that is output from the MAC scheduling unit 201. Then, the encoding unit 211 outputs the encoded data in the packet to the modulating unit 212. The modulating unit 212 modulates the data in the packet that is output from the encoding unit 211. Then, the modulating unit 212 outputs the modulated signal to the multiplexing unit 213.

The multiplexing unit 213 multiplexes the control information, which includes a reservation signal, or the like, output from the uplink managing unit 202, and a signal that is output from the modulating unit 212. Then, the multiplexing unit 213 outputs the multiplexed transmission signal to the IFFT processing unit 214.

The IFFT processing unit 214 performs IFFT processing on transmission signals that are output from the multiplexing unit 213. Thus, the transmission signal, output from the multiplexing unit 213, is converted from the frequency domain to the time domain. The IFFT processing unit 214 outputs the transmission signal, on which the IFFT processing has been performed, to the wireless processing unit 215.

The wireless processing unit 215 performs wireless processing on transmission signals that are output from the IFFT processing unit 214. The wireless processing, performed by the wireless processing unit 215, includes processing to convert for example the frequency of a transmission signal from the frequency of the base band to the frequency of the unlicensed band. The wireless processing unit 215 transmits the transmission signal, on which the wireless processing has been performed, via the antenna 216.

The Terminal 30

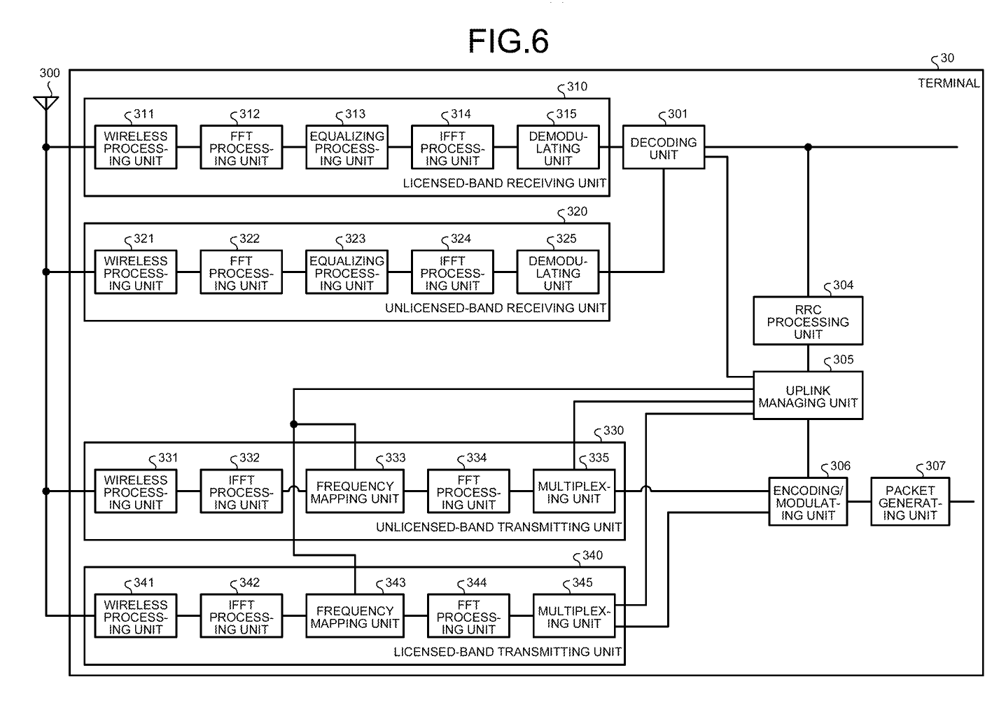

FIG. 6 is a block diagram that illustrates an example of the terminal 30 according to the first embodiment. The terminal 30 includes an antenna 300, a decoding unit 301, an RRC processing unit 304, an uplink managing unit 305, an encoding/modulating unit 306, and a packet generating unit 307. Furthermore, the terminal 30 includes a licensed-band receiving unit 310, an unlicensed-band receiving unit 320, an unlicensed-band transmitting unit 330, and a licensed-band transmitting unit 340. Furthermore, according to the present embodiment, the terminal 30 includes the single antenna 300. However, according to another embodiment, the antenna 300 may be separately provided for each of the licensed-band receiving unit 310, the unlicensed-band receiving unit 320, the unlicensed-band transmitting unit 330, and the licensed-band transmitting unit 340.

The licensed-band receiving unit 310 performs the process to demodulate data from signals that are received in the licensed band. The licensed-band receiving unit 310 includes a wireless processing unit 311, an FFT processing unit 312, an equalizing processing unit 313, an IFFT processing unit 314, and a demodulating unit 315.

The wireless processing unit 311 performs wireless processing on signals that are received via the antenna 300. The wireless processing, conducted by the wireless processing unit 311, includes processing to convert for example the frequency of a reception signal from the frequency of the licensed band to the frequency of the base band. The wireless processing unit 311 outputs the reception signal, on which the wireless processing has been performed, to the FFT processing unit 312.

The FFT processing unit 312 performs FFT processing on reception signals that are output from the wireless processing unit 311. Thus, the reception signal, output from the wireless processing unit 311, is converted from the time domain to the frequency domain. The FFT processing unit 312 outputs the reception signal, on which the FFT processing has been performed, to the equalizing processing unit 313. The equalizing processing unit 313 performs an equalizing process on the signal that is output from the FFT processing unit 312. Then, the equalizing processing unit 313 outputs the reception signal, on which the equalizing process has been performed, to the IFFT processing unit 314.

The IFFT processing unit 314 performs IFFT processing on the reception signal that is output from the equalizing processing unit 313. Thus, the reception signal, output from the equalizing processing unit 313, is converted from the frequency domain to the time domain. The IFFT processing unit 314 outputs the reception signal, on which the IFFT processing has been performed, to the demodulating unit 315.

The demodulating unit 315 demodulates the reception signal that is output from the IFFT processing unit 314. Then, the demodulating unit 315 outputs the demodulated reception signal to the decoding unit 301. The data that is decoded from the reception signal, demodulated by the licensed-band receiving unit 310, includes the information that specifies a modulation method, or the like, or the control information on a UL grant, or the like.

The unlicensed-band receiving unit 320 performs the process to demodulate data from signals that are received in the unlicensed band. The unlicensed-band receiving unit 320 includes a wireless processing unit 321, an FFT processing unit 322, an equalizing processing unit 323, an IFFT processing unit 324, and a demodulating unit 325.

The wireless processing unit 321 performs wireless processing on signals that are received via the antenna 300. The wireless processing, conducted by the wireless processing unit 321, includes processing to convert for example the frequency of a reception signal from the frequency of the unlicensed band to the frequency of the base band. The wireless processing unit 321 outputs the reception signal, on which the wireless processing has been performed, to the FFT processing unit 322.

The FFT processing unit 322 performs FFT processing on reception signals that are output from the wireless processing unit 321. Thus, the reception signal, output from the wireless processing unit 321, is converted from the time domain to the frequency domain. Then, the FFT processing unit 322 outputs the reception signal, on which the FFT processing has been performed, to the equalizing processing unit 323. The equalizing processing unit 323 performs an equalizing process on the reception signal that is output from the FFT processing unit 322. Then, the equalizing processing unit 323 outputs the reception signal, on which the equalizing process has been performed, to the IFFT processing unit 324.

The IFFT processing unit 324 performs IFFT processing on reception signals that are output from the equalizing processing unit 323. Thus, the reception signal, output from the equalizing processing unit 323, is converted from the frequency domain to the time domain. The IFFT processing unit 324 outputs the reception signal, on which the IFFT processing has been performed, to the demodulating unit 325.

The demodulating unit 325 demodulates reception signals that are output from the IFFT processing unit 324. Then, the demodulating unit 325 outputs the demodulated reception signal to the decoding unit 301. The data that is decoded from the reception signal, demodulated by the unlicensed-band receiving unit 320, includes the control information on reservation signals, or the like.

The decoding unit 301 decodes user data and control information from reception signals that are output from the licensed-band receiving unit 310 and the unlicensed-band receiving unit 320. Then, the decoding unit 301 outputs the decoded user data to, for example, an application processing unit (not illustrated) that performs processing on the basis of the user data. Furthermore, the decoding unit 301 outputs the decoded control information, or the like, to the RRC processing unit 304 and the uplink managing unit 305. The control information, which is output to the uplink managing unit 305, includes the information on a modulation method, or the like, selected during the MCS control, UL grant, reservation signals, or the like.

The RRC processing unit 304 conducts wireless resource control on the basis of the control information that is output from the decoding unit 301. The wireless resource control, conducted by the RRC processing unit 304, is processing on the RRC layer. The RRC processing unit 304 generates the control information in accordance with the wireless resource control and outputs the generated control information to the uplink managing unit 305.

The uplink managing unit 305 controls data transmission in the UL on the basis of the control information, output from the RRC processing unit 304, and the control signal, output from the decoding unit 301. For example, if the UL grant is output from the decoding unit 301, the uplink managing unit 305 acquires the information on a sub-band of the unlicensed band, or the like, from the UL grant. Then, the uplink managing unit 305 outputs the information on assignment of the resource, used for data transmission in the UL, to a frequency mapping unit 333 and a frequency mapping unit 343, described later.

Then, if a reservation signal is detected in the unlicensed band, the uplink managing unit 305 outputs a control signal, such as DMRS, to a multiplexing unit 335 and a multiplexing unit 345 at a predetermined time period after transmission of the reservation signal is finished. Then, the uplink managing unit 305 instructs the encoding/modulating unit 306, described later, to start data transmission in the UL.

The packet generating unit 307 generates data that includes user data that is output from for example an application processing unit (not illustrated). Then, the packet generating unit 307 outputs the generated data to the encoding/modulating unit 306. The encoding/modulating unit 306 performs encoding and modulation processes on the data, output from the packet generating unit 307, by using the coding rate and the modulation method, designated by the uplink managing unit 305. Then, the encoding/modulating unit 306 outputs transmission signals, on which encoding and modulation processes have been performed, to the unlicensed-band transmitting unit 330 or the licensed-band transmitting unit 340 in accordance with an instruction from the uplink managing unit 305.

The licensed-band transmitting unit 340 performs a process to transmit data in the licensed band. The licensed-band transmitting unit 340 includes a wireless processing unit 341, an IFFT processing unit 342, the frequency mapping unit 343, an FFT processing unit 344, and the multiplexing unit 345.

The multiplexing unit 345 multiplexes the control signal, output from the uplink managing unit 305, and the transmission signal, output from the encoding/modulating unit 306. Then, the multiplexing unit 345 outputs the multiplexed transmission signal to the FFT processing unit 344. The FFT processing unit 344 performs FFT processing on the transmission signal that is output from the multiplexing unit 345. Thus, the transmission signal, output from the multiplexing unit 345, is converted from the time domain to the frequency domain. The FFT processing unit 344 outputs the transmission signal, on which FFT processing has been conducted, to the frequency mapping unit 343.

The frequency mapping unit 343 conducts frequency mapping on transmission signals that are output from the FFT processing unit 344 on the basis of the information on assignment of the resource used for the UL, output from the uplink managing unit 305. Then, the frequency mapping unit 343 outputs the transmission signal, on which frequency mapping has been conducted, to the IFFT processing unit 342.

The IFFT processing unit 342 performs IFFT processing on transmission signals that are output from the frequency mapping unit 343. Thus, the transmission signals, output from the frequency mapping unit 343, are converted from the frequency domain to the time domain. The IFFT processing unit 342 outputs the transmission signal, on which the IFFT processing has been performed, to the wireless processing unit 341.

The wireless processing unit 341 performs wireless processing on transmission signals that are output from the IFFT processing unit 342. The wireless processing, conducted by the wireless processing unit 341, includes processing to convert for example the frequency of a transmission signal from the frequency of the base band to the frequency of the licensed band. The wireless processing unit 341 transmits transmission signals, on which wireless processing has been conducted, via the antenna 300.

The unlicensed-band transmitting unit 330 performs a process to transmit data in the unlicensed band. The unlicensed-band transmitting unit 330 includes a wireless processing unit 331, an IFFT processing unit 332, the frequency mapping unit 333, an FFT processing unit 334, and the multiplexing unit 335.

The multiplexing unit 335 multiplexes the control signal, output from the uplink managing unit 305, and the signal, output from the encoding/modulating unit 306. Then, the multiplexing unit 335 outputs the multiplexed transmission signal to the FFT processing unit 334. The FFT processing unit 334 performs FFT processing on transmission signals that are output from the multiplexing unit 335. Thus, transmission signals, output from the multiplexing unit 335, are converted from the time domain to the frequency domain. The FFT processing unit 334 outputs the transmission signal, on which the FFT processing has been performed, to the frequency mapping unit 333.

The frequency mapping unit 333 conducts frequency mapping on transmission signals that are output from the FFT processing unit 334 on the basis of the information on assignment of the resource used for the UL, output from the uplink managing unit 305. Then, the frequency mapping unit 333 outputs the transmission signal, on which frequency mapping has been conducted, to the IFFT processing unit 332.

The IFFT processing unit 332 performs IFFT processing on transmission signals that are output from the frequency mapping unit 333. Thus, the transmission signals, output from the frequency mapping unit 333, are converted from the frequency domain to the time domain. The IFFT processing unit 332 outputs the transmission signal, on which the IFFT processing has been performed, to the wireless processing unit 331.

The wireless processing unit 331 performs wireless processing on transmission signals that are output from the IFFT processing unit 332. The wireless processing, conducted by the wireless processing unit 331, includes processing to convert for example the frequency of a transmission signal from the frequency of the base band to the frequency of the unlicensed band. The wireless processing unit 331 transmits transmission signals, on which wireless processing has been conducted, via the antenna 300.

Process to Calculate the SIR Threshold

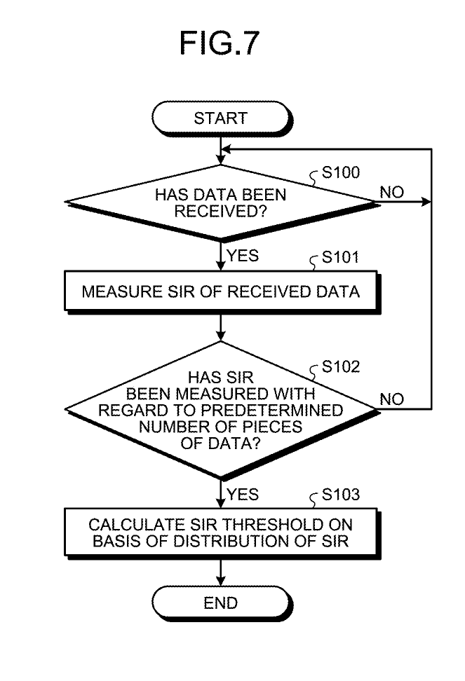

Next, the operation of the base station 20 is explained. FIG. 7 is a flowchart that illustrates an example of the process to calculate the SIR threshold. The base station 20 performs the process to calculate the SIR threshold, illustrated in this flowchart, for example at a predetermined timing before the operation is started or after the operation is started. Furthermore, it is preferable that the base station 20 stops the MCS outer loop control when the process is performed to calculate the SIR threshold.

First, the uplink managing unit 202 sets the CW size, used for the LBT, to the largest value that may be specified, and it transmits UL grant to the terminal 30. Then, the uplink managing unit 202 executes LBT and transmits a reservation signal to the unlicensed band. Then, on the basis of the output from the demodulating unit 232, the SIR measuring unit 209 determines whether data has been received from the terminal 30 in the unlicensed band (S100). If data has been received from the terminal 30 in the unlicensed band (S100: Yes), the SIR measuring unit 209 measures the SIR of the data (S101). Then, the SIR measuring unit 209 outputs a measurement result of the SIR to the threshold calculating unit 208.

Next, the threshold calculating unit 208 determines whether the SIR has been measured with regard to a predetermined number of pieces (e.g., several thousands to several tens of thousands of pieces) of data (S102). If the SIR has not been measured with regard to a predetermined number of pieces of data (S102: No), the SIR measuring unit 209 performs the operation that is illustrated in Step S100 again.

Conversely, if the SIR has been measured with regard to the predetermined number of pieces of data (S102: Yes), the threshold calculating unit 208 calculates the SIR threshold on the basis of the distribution of the SIR, calculated for each piece of reception data (S103). Then, the threshold calculating unit 208 outputs the calculated SIR threshold to the determining unit 207. Then, the base station 20 terminates the process that is illustrated in this flowchart.

MCS Outer Loop Control

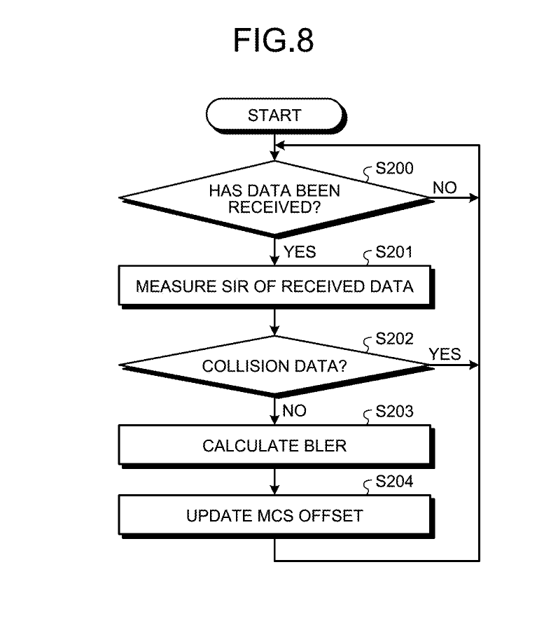

Next, an explanation is given of the MCS outer loop control in the UL, conducted by the base station 20. FIG. 8 is a flowchart that illustrates an example of the MCS outer loop control in the UL.

First, on the basis of the output from the demodulating unit 232, the SIR measuring unit 209 determines whether data has been received from the terminal 30 in the unlicensed band (S200). If data has been received from the terminal 30 in the unlicensed band (S200: Yes), the SIR measuring unit 209 measures the SIR of the received data (S201). Then, the SIR measuring unit 209 outputs a measurement result of the SIR to the determining unit 207.

The determining unit 207 determines whether the reception data is collision data on the basis of the measured value of the SIR, output from the SIR measuring unit 209, and the SIR threshold, calculated by the threshold calculating unit 208 (S202). According to the present embodiment, for each piece of reception data, the determining unit 207 determines that the reception data is non-collision data if the SIR, calculated by the SIR measuring unit 209, is equal to or more than the SIR threshold. Conversely, the determining unit 207 determines that the reception data is collision data if the SIR, calculated by the SIR measuring unit 209, is less than the SIR threshold.

If the determining unit 207 determines that the reception data is collision data (S202: Yes), the SIR measuring unit 209 performs the operation that is illustrated in Step S200 again. Conversely, if the determining unit 207 determines that the reception data is non-collision data (S202: No), the error-rate calculating unit 206 calculates BLER as the error rate in accordance with an error determination result of the reception data that is determined to be non-collision data by the determining unit 207 (S203). Then, the error-rate calculating unit 206 outputs the calculated BLER to the uplink managing unit 202.

Next, the uplink managing unit 202 updates the MCS offset to collect the index for selecting a modulation method, or the like, in accordance with the error rate that is calculated by the error-rate calculating unit 206 (S204). Then, the SIR measuring unit 209 performs the operation that is illustrated in Step S200 again. For example, if the error rate, calculated by the error-rate calculating unit 206, is higher than the target value, the uplink managing unit 202 decreases the MCS offset, which is added to the value of the index that indicates the SIR of the reception data, calculated by the SIR measuring unit 209. Furthermore, for example, if the error rate, calculated by the error-rate calculating unit 206, is lower than the target value, the uplink managing unit 202 increases the MCS offset.

Process to Change the Carrier Sense Threshold or the CW Size

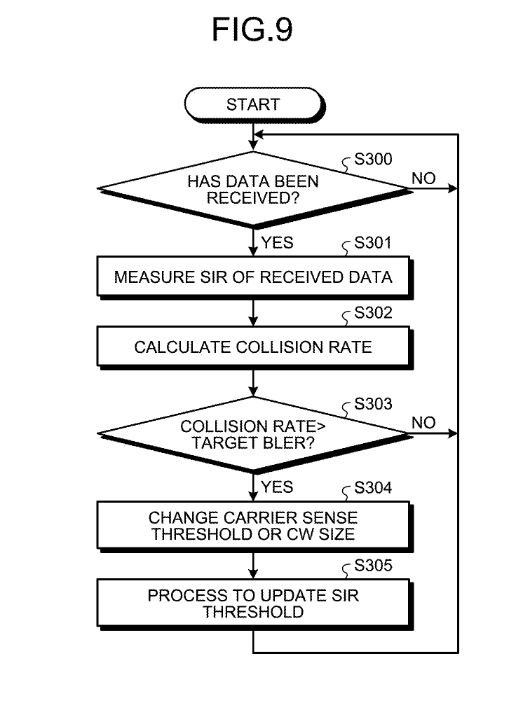

Next, an explanation is given of the process to change the carrier sense threshold or the CW size, performed by the base station 20. FIG. 9 is a flowchart that illustrates an example of the process to change the carrier sense threshold or the CW size.

First, the SIR measuring unit 209 determines whether data has been received from the terminal 30 on the basis of the output from the demodulating unit 232 (S300). If data has been received (S300: Yes), the SIR measuring unit 209 measures the SIR of the data (S301). Then, the SIR measuring unit 209 outputs a measurement result of the SIR to the determining unit 207.

The determining unit 207 determines whether the reception data is collision data on the basis of the measured value of the SIR, output from the SIR measuring unit 209, and the SIR threshold, calculated by the threshold calculating unit 208. Then, the determining unit 207 outputs a determination result of each piece of reception data to the collision-rate calculating unit 205. The collision-rate calculating unit 205 calculates the collision rate, which indicates the ratio of collision data to the reception data, in accordance with a determination result that is output from the determining unit 207 (S302). Then, the collision-rate calculating unit 205 outputs the calculated collision rate to the uplink managing unit 202.

Next, the uplink managing unit 202 determines whether the collision rate, calculated by the collision-rate calculating unit 205, is more than the target BLER, which is the target value of the error rate (S303). If the collision rate is equal to or less than the target BLER (S303: No), the SIR measuring unit 209 performs the operation that is illustrated in Step S300 again.

Conversely, if the collision rate is more than the target BLER (S303: Yes), the uplink managing unit 202 changes at least any one of the CW size and the carrier sense threshold (S304). According to the present embodiment, if the collision rate is more than the target BLER, the uplink managing unit 202 increases the CW size and also instructs the carrier sense unit 250 to decrease the carrier sense threshold. The uplink managing unit 202 may increase the CW size for LBT by a predetermined length or may increase it by two times. Furthermore, the uplink managing unit 202 may instruct the carrier sense unit 250 to decrease the carrier sense threshold by a predetermined rate (e.g., 0.5 dB).

Next, the base station 20 performs the process to update the SIR threshold (S305), and the SIR measuring unit 209 performs the operation that is illustrated in Step S300 again. At Step S305, the process to calculate the SIR threshold, explained with reference to FIG. 7, is performed.

The first embodiment has been explained above. As it is understood from the above explanation, the wireless communication system 10 according to the present embodiment makes it possible to improve the throughput in the UL if the base station 20 detects a vacancy in the band at a predetermined frequency and then the terminal 30 uses the band to transmit data in the UL to the base station 20.

Furthermore, the base station 20 according to the present embodiment calculates the SIR threshold on the basis of the distribution of the SIR of reception data and discriminates between collision data and non-collision data on the basis of the calculated SIR threshold. Thus, the base station 20 according to the present embodiment can discriminate between collision data and non-collision data with high accuracy.

Furthermore, the base station 20 according to the present embodiment changes at least any one of the CW size and the carrier sense threshold such that the collision rate of the reception data becomes lower than the target value of the error rate. Thus, the collision rate can be lower than the target value of the error rate, and the target value of the error rate can be achieved.

### [b] Second Embodiment

According to the first embodiment, the base station 20 executes LBT in the unlicensed band before the terminal 30 transmits data in the UL. Conversely, the wireless communication system 10 according to the present embodiment is different from that according to the first embodiment in that the terminal 30 executes LBT in the unlicensed band before the terminal 30 transmits data in the UL.

The Base Station 20

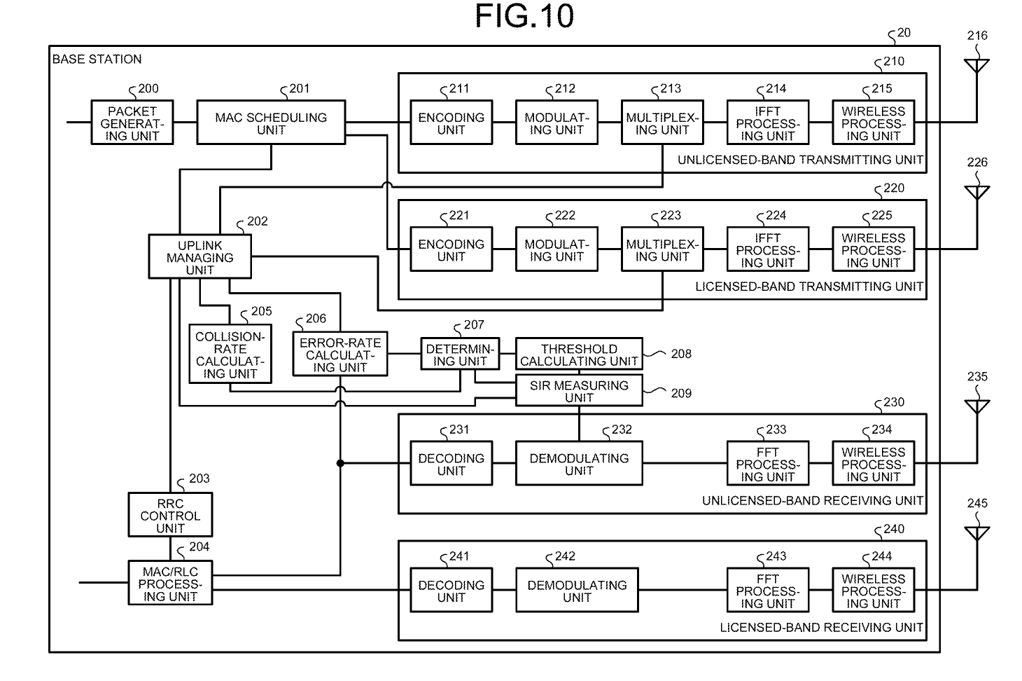

FIG. 10 is a block diagram that illustrates an example of the base station 20 according to the second embodiment. Furthermore, except for the aspect that is explained below, the component in FIG. 10, attached with the same reference numeral as that in FIG. 3, is the same as the component that is explained in FIG. 3, and therefore detailed explanations are omitted. The base station 20 according to the present embodiment is different from the base station 20 according to the first embodiment in that the carrier sense unit 250 is not provided.

The uplink managing unit 202 controls at least any one of the CW size and the carrier sense threshold, used by the terminal 30, in accordance with a comparison result between the collision rate, output from the collision-rate calculating unit 205, and the target value of the error rate. For example, if the collision rate, output from the collision-rate calculating unit 205, is more than the target value of the error rate, the uplink managing unit 202 generates the control information that includes an instruction to increase the CW size or an instruction to decrease the carrier sense threshold. Then, the uplink managing unit 202 outputs the generated control information to the multiplexing unit 223. Thus, the control information, which includes an instruction to increase the CW size or an instruction to decrease the carrier sense threshold, is transmitted to the terminal 30 in the licensed band.

The Terminal 30

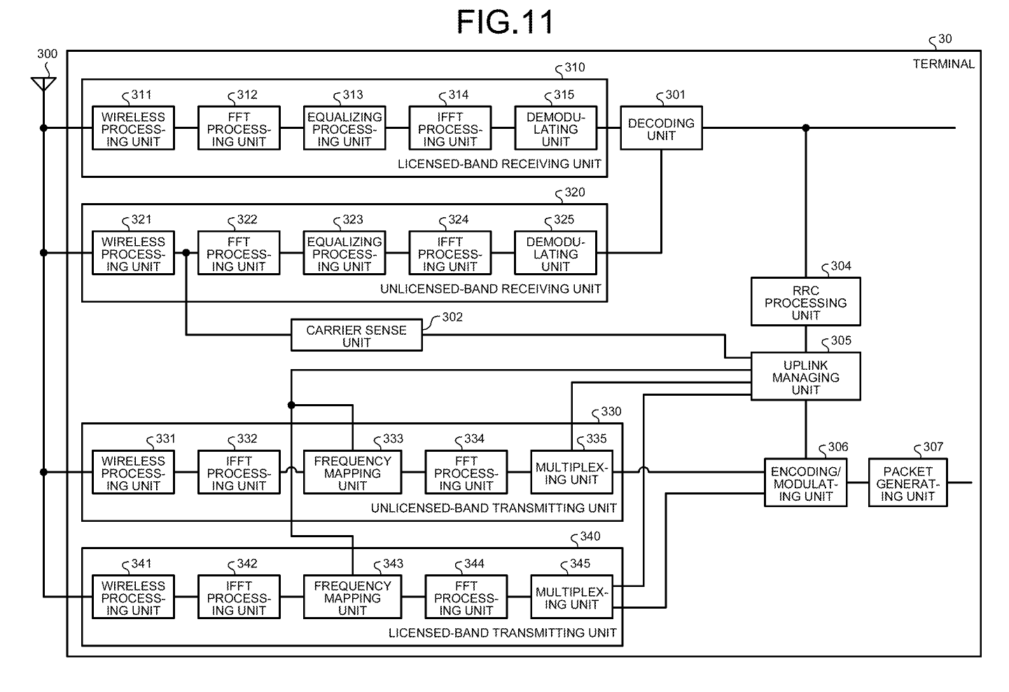

FIG. 11 is a block diagram that illustrates an example of the terminal 30 according to the second embodiment. Furthermore, except for the aspect that is explained below, the component in FIG. 11, attached with the same reference numeral as that in FIG. 6, is the same as the component that is explained in FIG. 6, and therefore detailed explanations are omitted. The terminal 30 according to the present embodiment is different from the terminal 30 according to the first embodiment in that a carrier sense unit 302 is provided.

The carrier sense unit 302 conducts carrier sense in the unlicensed band on the basis of reception signals that are output from the wireless processing unit 321. The carrier sense unit 302 determines that the unlicensed band is busy if the interference power of the unlicensed band is equal to or more than the carrier sense threshold. Conversely, the carrier sense unit 302 determines that the unlicensed band is idle if the interference power of the unlicensed band is less than the carrier sense threshold. Then, the carrier sense unit 302 outputs a determination result of the carrier sense to the uplink managing unit 305. Furthermore, the carrier sense unit 302 changes the carrier sense threshold in accordance with an instruction from the uplink managing unit 305.

The uplink managing unit 305 executes the LBT in the unlicensed band in accordance with a determination result that is output from the carrier sense unit 302 at a predetermined timing (e.g., after 3 sub-frames) after the UL grant is received from the base station 20. Then, if the idleness of the unlicensed band is detected, the uplink managing unit 305 instructs the encoding/modulating unit 306 to start data transmission in the UL after it is confirmed that the idleness continues during the backoff period, which is selected in the CW size in a random manner.

Furthermore, if the control information, which includes an instruction to increase the CW size, is received from the base station 20, the uplink managing unit 305 changes the CW size, used for the LBT, so as to increase in accordance with the received instruction. Furthermore, if the control information, which includes an instruction to decrease the carrier sense threshold, is received from the base station 20, the uplink managing unit 305 calculates the carrier sense threshold that corresponds to the received instruction and instructs the calculated carrier sense threshold to the carrier sense unit 302.

The second embodiment has been explained above. As it is understood from the above explanation, the wireless communication system 10 according to the present embodiment changes at least any one of the CW size for the LBT, conducted by the terminal 30, and the carrier sense threshold such that the collision rate of reception data becomes lower than the target value of the error rate. Thus, even if the terminal 30 executes the LBT, the collision rate can be lower than the target value of the error rate, and the target value of the error rate in the UL can be achieved.

### [c] Third Embodiment

The Wireless Communication System 10

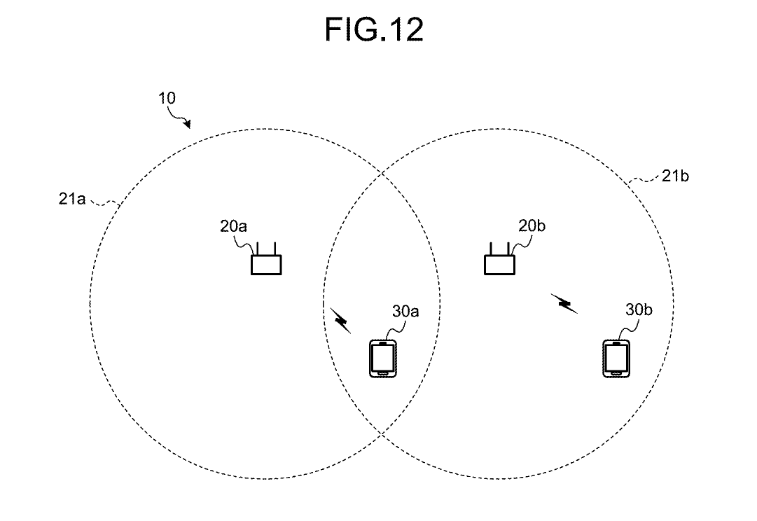

In the first embodiment and the second embodiment, an explanation is principally given of operations of the base station 20 and the terminal 30 in the UL from the terminal 30 to the base station 20. Conversely, in the present embodiment, an explanation is principally given of operations of the base station 20 and the terminal 30 in a down link (DL) from the base station 20 to the terminal 30. FIG. 12 is a diagram that illustrates an example of the wireless communication system 10. In FIG. 12, the reference numeral 21a denotes the range within which the radio waves, transmitted from the base station 20a, reach with such intensity that it is determined to be busy during the carrier sense by any communication device. Furthermore, the reference numeral 21b denotes the range within which the radio waves, transmitted from the base station 20b, reach with such intensity that it is determined to be busy during the carrier sense by any communication device. Furthermore, except for the aspect that is explained below, the component in FIG. 12, attached with the same reference numeral as that in FIG. 1, is the same as the component that is explained in FIG. 1, and therefore detailed explanations are omitted.

If a data transmission request is generated for the terminal 30, the base station 20 according to the present embodiment generates DL assignment to designate the resource of the unlicensed band for conducting data transmission in the DL. Then, the base station 20 transmits the generated DL assignment to the terminal 30 in the licensed band. The DL assignment contains information, such as the frequency of the unlicensed band, used for data transmission in the DL, transmission timing, or the like.

The base station 20 executes LBT at predetermined timing (e.g., after 3 sub-frames) after the DL assignment is transmitted. Then, the base station 20 transmits a reservation signal to the unlicensed band after it is confirmed that the idle state of the unlicensed band continues during the backoff period, which is selected in a random manner. Then, the base station 20 transmits data to the terminal 30 by using the resource of the unlicensed band, designated in the DL assignment, at predetermined timing (e.g., after 4 sub-frames) after the DL assignment is transmitted.

Here, in the wireless communication system 10 that is illustrated in FIG. 12, when the base station 20b transmits data to the terminal 30b, the radio waves, transmitted from the base station 20b, do not reach the base station 20a. Therefore, the base station 20a sometimes determines that the unlicensed band is idle due to LBT even when the base station 20b transmits data to the terminal 30b. Therefore, the base station 20a transmits a reservation signal in the unlicensed band after the DL assignment is transmitted to the terminal 30a. Then, the base station 20a transmits data to the terminal 30a in the unlicensed band at predetermined timing after the DL assignment is transmitted.

If the base station 20b transmits data to the terminal 30b, the data, transmitted from the base station 20a to the terminal 30a, sometimes collides with the data that is transmitted from the base station 20b. Therefore, there is an increase in the error rate of the data that is received by the terminal 30a from the base station 20a.

Here, the base station 20 according to the present embodiment causes the terminal 30 to feed back the index that indicates the quality of reception signals, measured by the terminal 30. Then, the base station 20 conducts MCS control to select a modulation method, or the like, used for data transmission in the DL, on the basis of the index that is received from the terminal 30.

Furthermore, the base station 20 according to the present embodiment causes the terminal 30 to feed back the error rate of reception data, measured by the terminal 30, and executes MCS outer loop control on the basis of the error rate that is measured by the terminal 30. During the MCS outer loop control, the index for selecting a modulation method, or the like, is corrected on the basis of the error rate, measured by the terminal 30, such that the error rate of reception data in the terminal 30 becomes close to the target value.

Here, if the data, transmitted from the base station 20 to the terminal 30, collides with the data that is transmitted from a different communication device, there is an increase in the error rate of the data that is received by the terminal 30. If the MCS outer loop control in the DL is conducted in accordance with the average value of the error rate of reception data, a modulation method, or the like, with a low transmission rate is selected even in a state where data collisions do not occur. This results in a decrease in the transmission rate in the DL.

To prevent this, the base station 20 according to the present embodiment discriminates between collision data and non-collision data among the data that is received by the terminal 30 from the base station 20. Then, the terminal 30 calculates an error rate by using non-collision data and feeds back the calculated error rate to the base station 20. The base station 20 executes the MCS outer loop control in the DL on the basis of the error rate that is fed back from the terminal 30. Thus, the throughput of the DL can be improved in a state where data collisions do not occur, and the overall throughput of the DL can be improved.

The Base Station 20

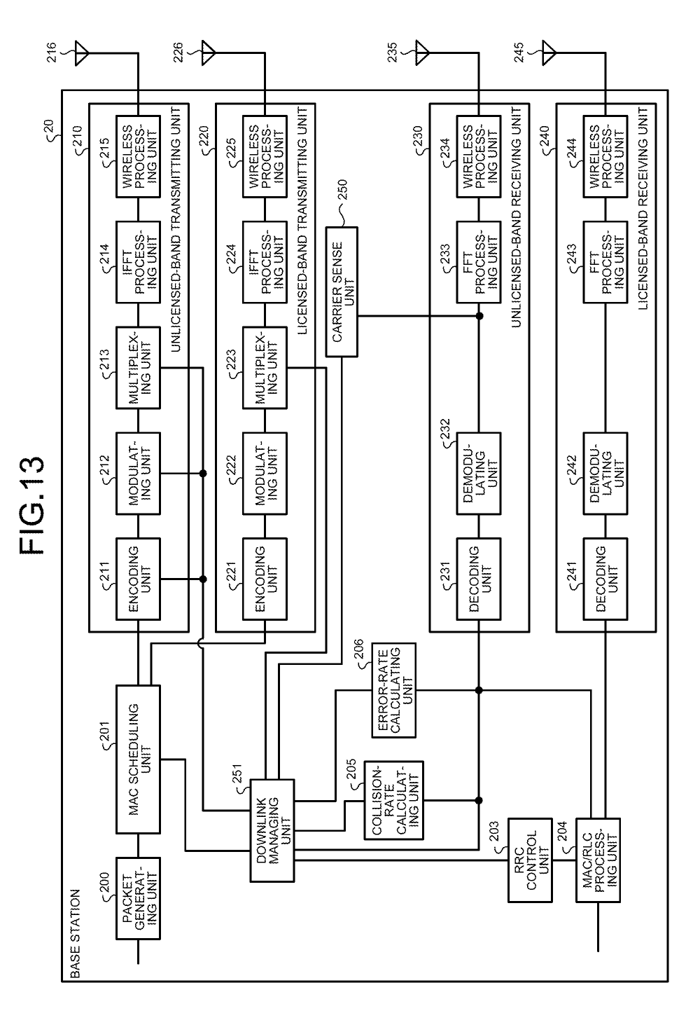

FIG. 13 is a block diagram that illustrates an example of the base station 20 according to a third embodiment. Furthermore, except for the aspect that is explained below, the component in FIG. 13, attached with the same reference numeral as that in FIG. 3, is the same as the component that is explained in FIG. 3, and therefore detailed explanations are omitted. The base station 20 according to the present embodiment is different from the base station 20 according to the first embodiment in that it includes a downlink managing unit 251 and it does not include the uplink managing unit 202, the determining unit 207, the threshold calculating unit 208, or the SIR measuring unit 209.

The error-rate calculating unit 206 receives a reply signal from the decoding unit 231 with regard to the data that is transmitted in the DL from the base station 20 to the terminal 30. The error-rate calculating unit 206 calculates the error rate of reception data in the terminal 30 on the basis of the reply signal with regard to non-collision data. Then, the error-rate calculating unit 206 outputs the calculated error rate to the downlink managing unit 251.

The reply signal includes acknowledgement (ACK), which indicates reception success, or negative acknowledgement (NACK), which indicates reception failure. Furthermore, the reply signal includes the collision information that indicates whether the data, received by the terminal 30, is collision data or not. According to the present embodiment, the reply signal includes two bits in total, i.e., the error bit that indicates whether it is ACK or NACK and the collision bit that indicates whether it is collision data or not. Furthermore, according to another embodiment, the reply signal may include the information of two bits for identifying three states, i.e., ACK, NACK with regard to non-collision data, and NACK with regard to collision data.

The collision-rate calculating unit 205 receives a reply signal with regard to the data, transmitted in the DL from the base station 20 to the terminal 30, from the decoding unit 231. On the basis of the reply signal, the collision-rate calculating unit 205 calculates the ratio of collision data to the data that is transmitted in the DL from the base station 20 to the terminal 30. Then, the collision-rate calculating unit 205 outputs the calculated collision rate to the downlink managing unit 251.

If data is generated to be transmitted to the terminal 30, the downlink managing unit 251 generates DL assignment that designates the resource, or the like, of the unlicensed band, used for data transmission in the DL. Then, the downlink managing unit 251 outputs the generated DL assignment to the multiplexing unit 223.

Furthermore, the downlink managing unit 251 executes LBT in the unlicensed band in accordance with a determination result, output from the carrier sense unit 250, at predetermined timing (e.g., after 3 sub-frames) after the DL assignment is transmitted to the terminal 30. Then, if the idleness of the unlicensed band is detected, the downlink managing unit 251 generates a reservation signal and outputs the generated reservation signal to the multiplexing unit 213.

Furthermore, the downlink managing unit 251 stores the correspondence table, which stores the combination of a modulation method and a coding rate, in relation to the index that indicates the SIR of the DL. The downlink managing unit 251 receives the reception data that includes the index (e.g., CQI: Channel Quality Indicator) that indicates the SIR of the DL, measured by the terminal 30, from the decoding unit 231. Then, on the basis of the received index, the downlink managing unit 251 executes MCS control to select a modulation method, or the like, used for data transmission in the DL to the terminal 30.

For example, the downlink managing unit 251 refers to the correspondence table and, on the basis of the index that is received from the terminal 30 for each piece of reception data, selects the modulation method and the coding rate that are related to the index. Then, the downlink managing unit 251 outputs the control signal that specifies the selected modulation method to the encoding unit 211 and outputs the control signal that specifies the selected coding rate to the modulating unit 212.

Furthermore, the downlink managing unit 251 executes MCS outer loop control to correct the index for selecting a modulation method, or the like, on the basis of the error rate that is calculated by the error-rate calculating unit 206. For example, the downlink managing unit 251 adjusts the value of the MCS offset, which is added to the value of the index, received from the terminal 30, depending on whether the error rate, calculated by the error-rate calculating unit 206, is higher than the target value.

Furthermore, the downlink managing unit 251 controls at least any one of the CW size and the carrier sense threshold such that the collision rate, output from the collision-rate calculating unit 205, becomes less than the target value of the error rate. For example, if the collision rate, output from the collision-rate calculating unit 205, is larger than the target value of the error rate, the downlink managing unit 251 increases the CW size or instructs the carrier sense unit 250 to lower the carrier sense threshold.

The Terminal 30

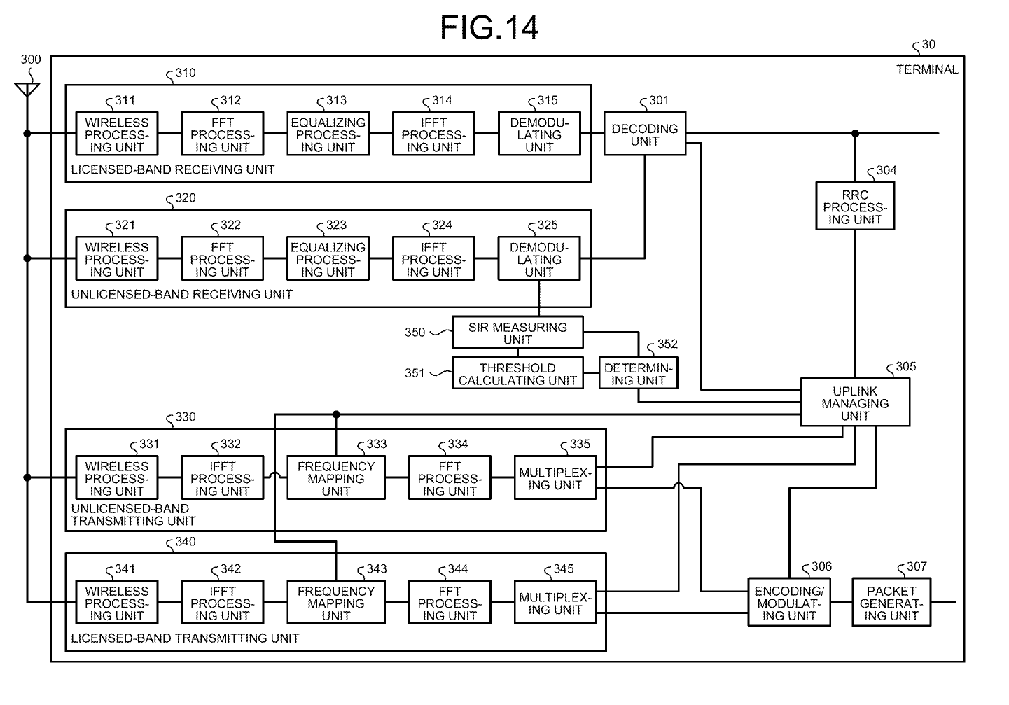

FIG. 14 is a block diagram that illustrates an example of the terminal 30 according to the third embodiment. Furthermore, except for the aspect that is explained below, the component in FIG. 14, attached with the same reference numeral as that in FIG. 6, is the same as the component that is explained in FIG. 6, and therefore detailed explanations are omitted. The terminal 30 according to the present embodiment is different from the terminal 30 according to the first embodiment in that it includes an SIR measuring unit 350, a threshold calculating unit 351, and a determining unit 352.

The SIR measuring unit 350 measures the SIR of each piece of data, received from the base station 20, on the basis of the reception signal that is output from the demodulating unit 325. Then, the SIR measuring unit 350 outputs the SIR, calculated for each piece of reception data, to the threshold calculating unit 351 and the determining unit 352. Here, the method of calculating the SIR by the SIR measuring unit 350 is the same as the method of calculating the SIR by the SIR measuring unit 209, explained in the first embodiment, and therefore explanations are omitted.

The threshold calculating unit 351 calculates the SIR threshold, which is a threshold for determining whether reception data is collision data or non-collision data on the basis of the distribution of the SIR, calculated by the SIR measuring unit 350 for each piece of reception data. Then, the threshold calculating unit 351 outputs the calculated SIR threshold to the determining unit 352. Here, the method of calculating the SIR threshold by the threshold calculating unit 351 is the same as the method of calculating the SIR threshold by the threshold calculating unit 208, explained in the first embodiment, and therefore explanations are omitted.

Furthermore, in the same manner as the threshold calculating unit 208 according to the first embodiment, the threshold calculating unit 351 according to the present embodiment also performs the process to calculate the SIR threshold for example at predetermined timing before an operation is started or after an operation is started. For example, the downlink managing unit 251 of the base station 20 sets the CW size, used for the LBT, to the largest value that may be specified and transmits the DL assignment to the terminal 30. Then, the downlink managing unit 251 executes LBT and transmits a reservation signal to the unlicensed band. On the basis of the output from the demodulating unit 325, the SIR measuring unit 350 of the terminal 30 measures the SIR of data that is received from the base station in the unlicensed band. Then, if the SIR has been measured with regard to predetermined number of pieces (e.g., several thousands to several tens of thousands of pieces) of data, the threshold calculating unit 351 calculates the SIR threshold on the basis of the distribution of the SIR, calculated for each piece of reception data. Furthermore, for example, if the downlink managing unit 251 of the base station 20 changes at least any one of the CW size and the carrier sense threshold on the basis of the collision rate, which is output from the collision-rate calculating unit 205, the threshold calculating unit 351 performs the process to calculate the SIR threshold.

For each piece of reception data, the determining unit 352 compares the SIR, calculated by the SIR measuring unit 350, and the SIR threshold, calculated by the threshold calculating unit 351, thereby determining whether the reception data is collision data or non-collision data. Then, the determining unit 352 outputs a determination result of each piece of reception data to the uplink managing unit 305.

The decoding unit 301 decodes reception data from reception signals, output from the unlicensed-band receiving unit 320 and determines an error of the reception data. Then, the decoding unit 301 outputs an error determination result of each piece of reception data to the uplink managing unit 305.

For each piece of data that is received in the unlicensed band, the uplink managing unit 305 receives a result of the error determination from the decoding unit 301. Then, the uplink managing unit 305 determines the value of the error bit, which indicates ACK or NACK, on the basis of the error determination result for each piece of received data.

Furthermore, for each piece of data that is received in the unlicensed band, the uplink managing unit 305 receives a determination result, which indicates whether it is collision data or not, from the determining unit 352. Then, for each piece of received data, the uplink managing unit 305 determines the value of the collision bit, which indicates whether it is collision data or not, on the basis of the determination result that indicates whether it is collision data.

Then, the uplink managing unit 305 outputs reply signals, which include the error bit and the collision bit, to the multiplexing unit 335 at the transmission timing of reply signals to the reception data. Thus, the reply signals, which include the error bit and the collision bit, are transmitted to the base station 20 in the unlicensed band at the transmission timing of reply signals to reception data.

Operation of the Terminal 30

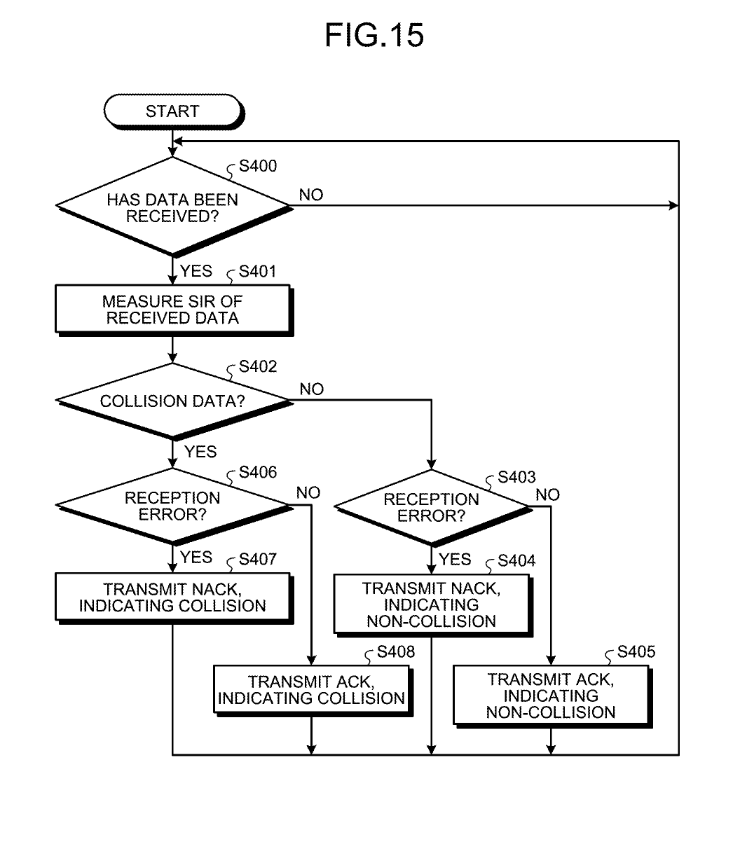

FIG. 15 is a flowchart that illustrates an example of the operation of the terminal 30 according to the third embodiment.

First, the SIR measuring unit 350 determines whether data has been received from the base station 20 in the unlicensed band on the basis of the output from the demodulating unit 325 (S400). If data has been received from the base station 20 in the unlicensed band (S400: Yes), the SIR measuring unit 350 measures the SIR of the received data (S401). Then, the SIR measuring unit 350 outputs a measurement result of the SIR to the determining unit 352.

The determining unit 352 determines whether the data, received from the base station 20, is collision data on the basis of the measured value of the SIR, output from the SIR measuring unit 350, and the SIR threshold, calculated by the threshold calculating unit 351 (S402). According to the present embodiment, for each piece of reception data, the determining unit 352 determines that reception data is non-collision data if the SIR, calculated by the SIR measuring unit 350, is equal to or more than the SIR threshold. Conversely, the determining unit 352 determines that reception data is collision data if the SIR, calculated by the SIR measuring unit 350, is less than the SIR threshold.

If the determining unit 352 determines that the reception data is non-collision data (S402: No), the uplink managing unit 305 determines whether the received data has been determined to be a reception error in accordance with a determination result by the decoding unit 301 (S403). If the received data has been determined to be a reception error (S403: Yes), the uplink managing unit 305 generates the reply signal that includes the error bit, which indicates NACK, and the collision bit, which indicates that it is non-collision data. Then, the uplink managing unit 305 transmits the generated reply signal to the base station 20 via the unlicensed-band transmitting unit 330 (S404). Then, the SIR measuring unit 350 performs the process, illustrated in Step S400, again. Conversely, if the received data has not been determined to be a reception error (S403: No), the uplink managing unit 305 generates the reply signal that includes the error bit, which indicates ACK, and the collision bit, which indicates that it is non-collision data. Then, the uplink managing unit 305 transmits the generated reply signal to the base station 20 via the unlicensed-band transmitting unit 330 (S405). Then, the SIR measuring unit 350 performs the process, illustrated in Step S400, again.

Conversely, if the determining unit 352 determines that the reception data is collision data (S402: Yes), the uplink managing unit 305 determines whether the received data has been determined to be a reception error in accordance with a determination result by the decoding unit 301 (S406). If the received data has been determined to be a reception error (S406: Yes), the uplink managing unit 305 generates the reply signal that includes the error bit, which indicates NACK, and the collision bit, which indicates that it is collision data. Then, the uplink managing unit 305 transmits the generated reply signal to the base station 20 via the unlicensed-band transmitting unit 330 (S407). Then, the SIR measuring unit 350 performs the process, illustrated in Step S400, again. Conversely, if the received data has not been determined to be a reception error (S406: No), the uplink managing unit 305 generates the reply signal that includes the error bit, which indicate ACK, and the collision bit, which indicates that it is collision data. Then, the uplink managing unit 305 transmits the generated reply signal to the base station 20 via the unlicensed-band transmitting unit 330 (S408). Then, the SIR measuring unit 350 performs the process, illustrated in Step S400, again.

MCS Outer Loop Control

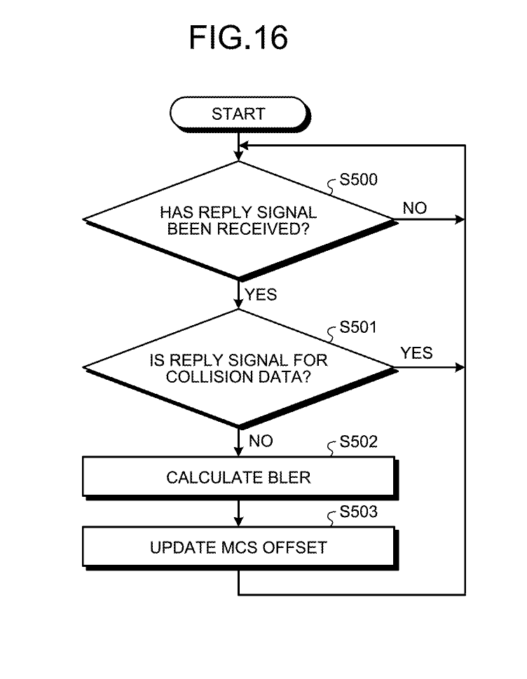

Next, an explanation is given of the MCS outer loop control in the DL, executed by the base station 20. FIG. 16 is a flowchart that illustrates an example of the MCS outer loop control in the DL.

First, the error-rate calculating unit 206 determines whether the reply signal has been received from the terminal 30 in the unlicensed band on the basis of the reception data that is output from the decoding unit 231 (S500). If the reply signal has been received (S500: Yes), the error-rate calculating unit 206 refers to the collision bit, included in the reply signal, to determine whether it is the reply signal for the reception data that has been determined to be collision data (S501). If the reply signal has not been received (S500: No) or if the reply signal has been received for the reception data that has been determined to be collision data (S501: Yes), the error-rate calculating unit 206 performs the process, illustrated in Step S500, again.

Conversely, if the reply signal has been received for the reception data that has been determined to be non-collision data (S501: No), the error-rate calculating unit 206 calculates BLER as the error rate of the reception data in the terminal 30 on the basis of the reply signal with regard to non-collision data (S502). Then, the error-rate calculating unit 206 outputs the calculated BLER to the downlink managing unit 251.

Next, the downlink managing unit 251 updates the MCS offset to correct the index for selecting a modulation method, or the like, in the DL on the basis of the error rate that is calculated by the error-rate calculating unit 206 (S503). Then, the error-rate calculating unit 206 performs the process, illustrated in Step S500, again.

The third embodiment has been explained above. As it is understood from the above explanation, the wireless communication system 10 according to the present embodiment makes it possible to improve the throughput in the DL if the base station 20 detects a vacancy in the band at a predetermined frequency and then the base station 20 uses the band to transmit data to the terminal 30.

Hardware

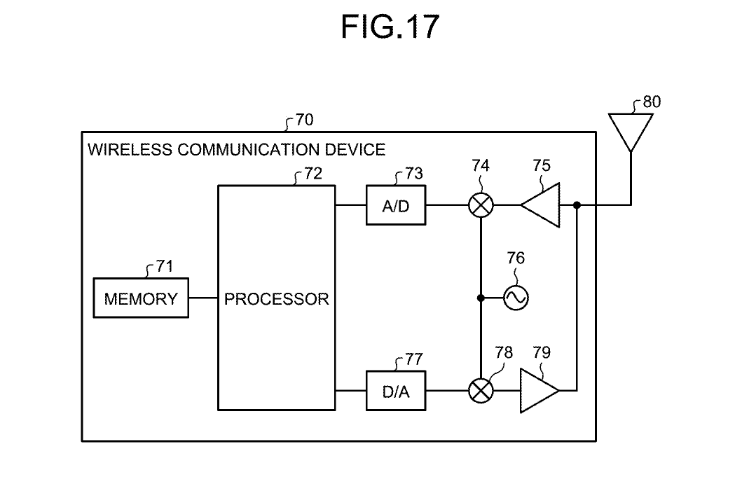

The base station 20 and the terminal 30 according to the above-described embodiment may be implemented by using for example a wireless communication device 70 that is illustrated in FIG. 17. FIG. 17 is a diagram that illustrates an example of the wireless communication device 70 that performs the function of the base station 20 or the terminal 30. The wireless communication device 70 includes, for example, a memory 71, a processor 72, an analog-digital converter (A/D) 73, a multiplier 74, an amplifier 75, an oscillator 76, a digital-analog converter (D/A) 77, a multiplier 78, an amplifier 79, and an antenna 80. Furthermore, in addition, the wireless communication device 70 may include an interface that performs wired communication with an external communication device.

The antenna 80 receives radio signals and outputs the received signals to the amplifier 75. Furthermore, the antenna 80 transmits signals, output from the amplifier 79, to an external unit. The amplifier 75 amplifies the signals, received by the antenna 80, and outputs the amplified signals to the multiplier 74. The multiplier 74 multiplies signals, output from the amplifier 75, and clock signals, output from the oscillator 76, thereby converting the frequency of the reception signal from the high-frequency band to the base band. Then, the multiplier 74 outputs the signal, whose frequency has been converted, to the analog-digital converter 73. The analog-digital converter 73 converts analog reception signals, output from the multiplier 74, into digital reception signals and outputs the converted reception signals to the processor 72.

The processor 72 performs the overall control on the wireless communication device 70. The processor 72 is implemented by using, for example, a central processing unit (CPU) or a digital signal processor (DSP). The processor 72 performs the process to receive signals that are output from the analog-digital converter 73. Furthermore, the processor 72 generates transmission signals and outputs the generated transmission signals to the digital-analog converter 77.

The memory 71 includes, for example, a main memory and an auxiliary memory. The main memory is for example a random access memory (RAM). The main memory is used as a work area of the processor 72. The auxiliary memory is a non-volatile memory, such as a magnetic disk or a flash memory. The auxiliary memory stores various programs for operating the processor 72. The program, stored in the auxiliary memory, is loaded into the main memory and is executed by the processor 72.

The digital-analog converter 77 converts digital transmission signals, output from the processor 72, into analog transmission signals and outputs the converted transmission signals to the multiplier 78. The multiplier 78 multiplies transmission signals, converted by the digital-analog converter 77, by clock signals that are output from the oscillator 76, thereby converting the frequency of the transmission signal from the base band to the high-frequency band. Then, the multiplier 78 outputs the transmission signal, whose frequency has been converted, to the amplifier 79. The amplifier 79 amplifies signals, output from the multiplier 78, and transmits the amplified transmission signal to an external unit via the antenna 80.

The oscillator 76 generates clock signals (alternating-current signals of continuous wave) at a predetermined frequency. Then, the oscillator 76 outputs the generated clock signals to the multiplier 74 and the multiplier 78.

If the wireless communication device 70 serves as the base station 20, which is illustrated in FIG. 3, 10, or 13, the antennas 216, 226, 235, and 245 in FIGS. 3, 10, and 13 may be implemented by using for example the antenna 80. Furthermore, the wireless processing units 215, 225, 234, and 244, illustrated in FIGS. 3, 10, and 13, may be implemented by using, for example, the analog-digital converter 73, the multiplier 74, the amplifier 75, the oscillator 76, the digital-analog converter 77, the multiplier 78, and the amplifier 79. Furthermore, the other components, illustrated in FIGS. 3, 10, and 13, may be implemented by using, for example, the processor 72 and the memory 71.

If the wireless communication device 70 serves as the terminal 30, illustrated in FIG. 6, 11, or 14, the antenna 300, illustrated in FIG. 6, 11, or 14, may be implemented by using for example the antenna 80. Furthermore, the wireless processing units 311, 321, 331, and 341, illustrated in FIGS. 6, 11, and 14, may be implemented by using for example the analog-digital converter 73, the multiplier 74, the amplifier 75, the oscillator 76, the digital-analog converter 77, the multiplier 78, and the amplifier 79. Furthermore, the other components, illustrated in FIG. 6, 11, or 14, may be implemented by using for example the processor 72 and the memory 71.

Others

In each of the above-described embodiments, the process to calculate the SIR threshold is performed when, for example, the CW size, or the like, for the LBT is changed such that the collision rate becomes lower than the target BLER; however, the disclosed technology is not limited thereto. For example, the process to calculate the SIR threshold may be performed at an interval of a predetermined period even in a state where the collision rate is lower than the target BLER. Thus, it is possible to calculate a more appropriate SIR threshold that corresponds to a movement of the base station 20, a change in the propagation environment, or the like.

Furthermore, in the above-described third embodiment, the terminal 30 transmits the reply signal, which includes the error bit and the collision bit, to the base station 20, and the base station 20 calculates the error rate of reception data in the terminal 30 with regard to non-collision data; however, the disclosed technology is not limited thereto. For example, the terminal 30 may calculate the error rate of reception data for each predetermined number of pieces of non-collision data and transmit the calculated error rate to the base station 20. In this case, the base station 20 executes the MCS outer loop control on the basis of the error rate that is transmitted from the terminal 30.

Furthermore, the components, illustrated in the above-described embodiment, are divided in accordance with functions depending on the primary processing details in order to facilitate understanding of each device. Therefore, the disclosed technology is not limited due to the way of dividing components or their names. The configuration of each device, illustrated in the above-described embodiment, may be divided into more components depending on the processing details, or they may be divided such that one component conducts more processes. Furthermore, each process may be implemented as a software process, and it may be implemented by dedicated hardware, such as an application specific integrated circuit (ASIC).

According to an aspect of the present application, it is possible to improve the throughput of data that is transmitted during the communication that is conducted by a base station and a terminal by using a band after a vacancy in the band at a predetermined frequency is detected.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A base station that is used in a wireless communication system in which the base station and a terminal perform a wireless communication by using a band after detecting a vacancy in the band at a predetermined frequency, the base station comprising:
a receiving unit that receives data that is transmitted from the terminal in the band;
a determining unit that determines whether data received by the receiving unit is collision data, which is data transmitted from the terminal at same time as a signal transmitted from a different communication device in the band, or non-collision data, which is not the collision data;
a calculating unit that calculates an error rate based on data that is determined to be non-collision data by the determining unit among data that are received by the receiving unit; and
a correcting unit that corrects an index, which is used to select a modulation method and a coding rate when the terminal transmits data, based on the error rate.

2. The base station according to claim 1, further comprising:
a measuring unit that measures a signal to interference ratio (SIR) for each piece of data that is received by the receiving unit; and
a threshold calculating unit that calculates an SIR threshold, which is a boundary between an SIR of the collision data and an SIR of the non-collision data, in accordance with a distribution of an SIR of data that is received by the receiving unit, wherein
the determining unit determines that data with an SIR that is equal to or more than the SIR threshold is the non-collision data and determines that data with an SIR that is less than the SIR threshold is the collision data among data that are received by the receiving unit.

3. The base station according to claim 1, further comprising:
a carrier sense unit that executes carrier sense;
an instructing unit that instructs the terminal to transmit data in a case where the carrier sense unit determines that the band is idle;
a collision-rate calculating unit that calculates a collision rate that indicates a ratio of the collision data to the data that are received by the receiving unit; and
a changing unit that changes at least any one of a carrier sense threshold and a Contention Window (CW) size, used by the carrier sense unit, such that the collision rate becomes lower than a target error rate.

4. The base station according to claim 1, further comprising:
a collision-rate calculating unit that calculates a collision rate that indicates a ratio of the collision data to the data that are received by the receiving unit; and
an instructing unit that instructs the terminal to change at least any one of a carrier sense threshold and a CW size, used during carrier sense by the terminal, such that the collision rate becomes lower than a target error rate.

5. A terminal that is used in a wireless communication system in which a base station and the terminal perform a wireless communication by using a band after detecting a vacancy in the band at a predetermined frequency, the terminal comprising:
a receiving unit that receives data that is transmitted from the base station in the band;
a determining unit that determines whether data received by the receiving unit is collision data, which is data transmitted from the base station at same time as a signal transmitted from a different communication device in the band, or non-collision data, which is not the collision data; and
a transmitting unit that transmits, to the base station, information that indicates whether each piece of data received by the receiving unit is any one of the collision data and the non-collision data.

6. The terminal according to claim 5, further comprising:
a measuring unit that measures an SIR for each piece of data that is received by the receiving unit; and
a threshold calculating unit that calculates an SIR threshold, which is a boundary between an SIR of the collision data and an SIR of the non-collision data, in accordance with a distribution of an SIR of data that is received by the receiving unit, wherein
the determining unit determines that data with an SIR that is equal to or more than the SIR threshold is the non-collision data and determines that data with an SIR that is less than the SIR threshold is the collision data among data that are received by the receiving unit.

7. A wireless communication system comprising a base station and a terminal, the base station and the terminal performing a wireless communication by using a band after detecting a vacancy in the band at a predetermined frequency, wherein
the base station includes
a first transmitting unit that transmits data to the terminal in the band;
a first receiving unit that receives, from the terminal, information that indicates whether each piece of data transmitted by the first transmitting unit is collision data, which is data transmitted from the first transmitting unit at same time as a signal transmitted from a different communication device in the band, or non-collision data, which is not the collision data;
a calculating unit that calculates an error rate of data, received by the terminal, based on information about the non-collision data that is received by the first receiving unit; and
a correcting unit that corrects an index, which is used to select a modulation method and a coding rate when the first transmitting unit transmits data, based on the error rate, and
the terminal includes
a second receiving unit that receives data that is transmitted from the base station in the band;
a determining unit that determines whether data received by the second receiving unit is any one of the collision data and the non-collision data; and
a second transmitting unit that transmits, to the base station, information that indicates whether each piece of data received by the second receiving unit is any one of the collision data and the non-collision data.
